(19) United States
(12) Patent Application Publication
(10) Pub. No.: US 2024/0086943 A1
(43) Pub. Date: Mar. 14, 2024

(54) CORRECTING COMPUTER-GENERATED MISATTRIBUTION ERRORS IN MEDIA IMPRESSIONS DATA USING A THIRD-PARTY PRIVACY-PROTECTED CLOUD ENVIRONMENT

(71) Applicant: The Nielsen Company (US), LLC, New York, NY (US)

(72) Inventors: Matthew VanLandeghem, Schaumburg, IL (US); Jessica Brinson, Chicago, IL (US); Sagar Sanghavi, Sunnyvale, CA (US); Lianghua Shao, Duarte, CA (US); Jonathan Sullivan, Hurricane, UT (US); Billie J. Kline, Inverness, FL (US); Mala Sivarajan, San Ramon, CA (US); Shruthi Koundinya Nagaraja, San Jose, CA (US); Logan Thomas, Sunnyvale, CA (US); Arushi Kumar, Hyattsville, MD (US)

(21) Appl. No.: 18/505,550

(22) Filed: Nov. 9, 2023

Related U.S. Application Data
(63) Continuation of application No. 17/984,982, filed on Nov. 10, 2022.
Application No. 17/984,982 is a continuation of application No. PCT/US2021/032062, filed on May 12, 2021.
Application No. PCT/US2021/032062 is a continuation of application No. 17/318,766, filed on May 12, 2021, now abandoned.
(60) Provisional application No. 63/024,260, filed on May 13, 2020.
(60) Provisional application No. 63/024,260, filed on May 13, 2020.

(51) Int. Cl. G06Q 30/0201; G06F 16/215; G06F 16/23; G06F 16/2457; G06F 16/28; G06F 16/9536; G06F 21/62; G06N 5/04; G06N 20/00; G06Q 30/0202; G06Q 30/0204; G06Q 30/0242; H04L 67/303; H04L 67/306; H04L 67/50; H04L 67/53

(52) U.S. Cl. CPC G06Q 30/0201; G06F 16/215; G06F 16/2365; G06F 16/24578; G06F 16/285; G06F 16/9536; G06F 21/6263; G06N 5/04; G06N 20/00; G06Q 30/0202; G06Q 30/0204; G06Q 30/0205; G06Q 30/0245; G06Q 30/0246; H04L 67/303; H04L 67/306; H04L 67/53; H04L 67/535

(57) ABSTRACT

Methods, apparatus, systems, and articles of manufacture are disclosed to adjust demographic information of user accounts to reflect primary users of the user accounts. An example apparatus includes memory, programmable circuitry, and instructions in the memory, the instructions to cause the programmable circuitry to at least access impression data associated with a user account registered with a database proprietor, the user account associated with first demographics at a database of the database proprietor. The example programmable circuitry is also to determine a primary user of the user account based on the impression data and based on second demographics of multiple users of the user account, the multiple users including the primary user. Additionally, the example programmable circuitry is to modify the first demographics associated with the user account based on at least some of the second demographics, the at least some of the second demographics corresponding to the primary user.

### RELATED APPLICATIONS

The present disclosure is a continuation of U.S. patent application Ser. No. 17/984,982, filed Nov. 10, 2022, which is a continuation of PCT Patent Application No. PCT/US2021/032062 and U.S. patent application Ser. No. 17/318,766, and claims priority to PCT Patent Application No. PCT/US2021/032062, filed May 12, 2021, and U.S. patent application Ser. No. 17/318,766, filed May 12, 2021. PCT Patent Application No. PCT/US2021/032062 and U.S. patent application Ser. No. 17/318,766 claim the benefit of U.S. Provisional Patent Application No. 63/024,260, filed May 13, 2020. PCT Patent Application No. PCT/US2021/032062; U.S. patent application Ser. No. 17/318,766; and U.S. Provisional Patent Application No. 63/024,260 are hereby incorporated herein by reference in their entireties. Priority to PCT Patent Application No. PCT/US2021/032062; U.S. patent application Ser. No. 17/318,766; and U.S. Provisional Patent Application No. 63/024,260 is hereby claimed.

Additionally, U.S. patent application Ser. No. 17/316,168, entitled “METHODS AND APPARATUS TO GENERATE COMPUTER-TRAINED MACHINE LEARNING MODELS TO CORRECT COMPUTER-GENERATED ERRORS IN AUDIENCE DATA,” which was filed on May 10, 2021, U.S. patent application Ser. No. 17/317,404, entitled “METHODS AND APPARATUS TO GENERATE AUDIENCE METRICS USING THIRD-PARTY PRIVACY-PROTECTED CLOUD ENVIRONMENTS,” which was filed on May 11, 2021, U.S. patent application Ser. No. 17/317,461, entitled “METHODS AND APPARATUS FOR MULTI-ACCOUNT ADJUSTMENT IN THIRD-PARTY PRIVACY-PROTECTED CLOUD ENVIRONMENTS,” which was filed on May 11, 2021, U.S. patent application Ser. No. 17/317,616, entitled “METHODS AND APPARATUS TO GENERATE AUDIENCE METRICS USING THIRD-PARTY PRIVACY-PROTECTED CLOUD ENVIRONMENTS,” which was filed on May 11, 2021, U.S. patent application Ser. No. 17/318,420, entitled “METHODS AND APPARATUS TO GENERATE AUDIENCE METRICS USING THIRD-PARTY PRIVACY-PROTECTED CLOUD ENVIRONMENTS,” which was filed on May 12, 2021, and U.S. patent application Ser. No. 17/318,517, entitled “METHODS AND APPARATUS TO GENERATE AUDIENCE METRICS USING THIRD-PARTY PRIVACY-PROTECTED CLOUD ENVIRONMENTS,” which was filed on May 12, 2021 are hereby incorporated herein by reference in their entireties.

### FIELD OF THE DISCLOSURE

This disclosure relates generally to computer systems for monitoring audiences, and, more particularly, to methods and apparatus to adjust demographic information of user accounts to reflect primary users of the user accounts.

### BACKGROUND

Audience measurement entities (AMEs) collect audience measurement information from panelists (e.g., individuals who agree to be monitored by the AMEs) including the number of unique audience members for particular media and the number of impressions of the media corresponding to each of the audience members. In some examples, AMEs utilize third-party cookies (e.g., where the AMEs are third parties relative to the entity serving media to a client device) to collect audience measurement information. In such examples, an AME may issue an impression request to the entity serving the media to client devices. Third-party cookie tracking is used by measurement entities to track access to media by client devices from first-party media servers.

### BRIEF DESCRIPTION OF THE DRAWINGS

FIG. 1 is a block diagram illustrating an example system to enable the generation of audience measurement metrics based on the merging of data collected by a database proprietor and an AME.

FIG. 2 is a block diagram illustrating the example system of FIG. 1 with different aspects of the system of FIG. 1 emphasized for clarity including an example impression-to-user analyzer.

FIG. 3 is a flowchart representative of machine readable instructions which may be executed to implement the privacy-protected cloud environment of FIG. 2.

FIG. 4 is a flowchart representative of machine readable instructions which may be executed to implement the example impression-to-user analyzer of FIG. 2 to determine primary users from among multiple potential users of panelist user accounts of the database proprietor 102.

FIG. 5 is another flowchart representative of machine readable instructions which may be executed to implement the example impression-to-user analyzer of FIG. 2 to determine primary users of panelist user accounts of the database proprietor.

FIG. 6 is a block diagram illustrating the example system of FIG. 1 with different aspects of the system of FIG. 1 emphasized for clarity.

FIG. 7 is a block diagram of an example processing platform structured to execute the instructions of FIGS. 3, 4, and/or 5 to implement the privacy-protected cloud environment and/or the impression-to-user analyzer of FIG. 2.

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

AMEs usually collect large amounts of audience measurement information from their panelists including the number of unique audience members for particular media and the number of impressions corresponding to each of the audience members. Unique audience size, as used herein, refers to the total number of unique people (e.g., non-duplicate people) who had an impression of (e.g., were exposed to) a particular media item, without counting duplicate audience members. As used herein, an impression is defined to be an event in which a home or individual accesses and/or is exposed to media (e.g., an advertisement, content, a group of advertisements and/or a collection of content). Impression count, as used herein, refers to the number of times audience members are exposed to a particular media item. The unique audience size associated with a particular media item will always be equal to or less than the number of impressions associated with the media item because, while all audience members by definition have at least one impression of the media, an individual audience member may have more than one impression. That is, the unique audience size is equal to the impression count only when every audience member was exposed to the media only a single time (i.e., the number of audience members equals the number of impressions). Where at least one audience member is exposed to the media multiple times, the unique audience size will be less than the total impression count because multiple impressions will be associated with individual audience members. Thus, unique audience size refers to the number of unique people in an audience (without double counting any person) exposed to media for which audience metrics are being generated. Unique audience size may also be referred to as unique audience, deduplicated audience size, deduplicated audience, or audience.

Techniques for monitoring user access to an Internet-accessible media, such as digital television (DTV) media and digital content ratings (DCR) media, have evolved significantly over the years. Internet-accessible media is also known as digital media. In the past, such monitoring was done primarily through server logs. In particular, media providers serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

As Internet technology advanced, the limitations of server logs were overcome through methodologies in which the Internet media to be tracked was tagged with monitoring instructions. In particular, monitoring instructions (also known as a media impression request or a beacon request) are associated with the hypertext markup language (HTML) of the media to be tracked. When a client requests the media, both the media and the impression request are downloaded to the client. The impression requests are, thus, executed whenever the media is accessed, be it from a server or from a cache.

The beacon instructions cause monitoring data reflecting information about the access to the media (e.g., the occurrence of a media impression) to be sent from the client that downloaded the media to a monitoring server. Typically, the monitoring server is owned and/or operated by an AME (e.g., any party interested in measuring or tracking audience exposures to advertisements, media, and/or any other media) that did not provide the media to the client and who is a trusted third party for providing accurate usage statistics (e.g., The Nielsen Company, LLC). Advantageously, because the beaconing instructions are associated with the media and executed by the client browser whenever the media is accessed, the monitoring information is provided to the AME irrespective of whether the client is associated with a panelist of the AME. In this manner, the AME is able to track every time a person is exposed to the media on a census-wide or population-wide level. As a result, the AME can reliably determine the total impression count for the media without having to extrapolate from panel data collected from a relatively limited pool of panelists within the population. Frequently, such beacon requests are implemented in connection with third-party cookies. Since the AME is a third party relative to the first party serving the media to the client device, the cookie sent to the AME in the impression request to report the occurrence of the media impression of the client device is a third-party cookie. Third-party cookie tracking is used by audience measurement servers to track access to media by client devices from first-party media servers.

Tracking impressions by tagging media with beacon instructions using third-party cookies is insufficient, by itself, to enable an AME to reliably determine the unique audience size associated with the media if the AME cannot identify the individual user associated with the third-party cookie. That is, the unique audience size cannot be determined because the collected monitoring information does not uniquely identify the person(s) exposed to the media. Under such circumstances, the AME cannot determine whether two reported impressions are associated with the same person or two separate people. The AME may set a third-party cookie on a client device reporting the monitoring information to identify when multiple impressions occur using the same device. However, cookie information does not indicate whether the same person used the client device in connection with each media impression. Furthermore, the same person may access media using multiple different devices that have different cookies so that the AME cannot directly determine when two separate impressions are associated with the same person or two different people.

Furthermore, the monitoring information reported by a client device executing the beacon instructions does not provide an indication of the demographics or other user information associated with the person(s) exposed to the associated media. To at least partially address this issue, the AME establishes a panel of users who have agreed to provide their demographic information and to have their Internet browsing activities monitored. When an individual joins the panel, that person provides corresponding detailed information concerning the person's identity and demographics (e.g., gender, race, income, home location, occupation, etc.) to the AME. The AME sets a cookie on the panelist computer that enables the AME to identify the panelist whenever the panelist accesses tagged media and, thus, sends monitoring information to the AME. Additionally or alternatively, the AME may identify the panelists using other techniques (independent of cookies) by, for example, prompting the user to login or identify themselves. While AMEs are able to obtain user-level information for impressions from panelists (e.g., identify unique individuals associated with particular media impressions), most of the client devices providing monitoring information from the tagged pages are not panelists. Thus, the identity of most people accessing media remains unknown to the AME such that it is necessary for the AME to use statistical methods to impute demographic information based on the data collected for panelists to the larger population of users providing data for the tagged media. However, panel sizes of AMEs remain small compared to the general population of users.

There are many database proprietors operating on the Internet. These database proprietors provide services to large numbers of subscribers. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. In exchange for the provision of services, the subscribers register with the database proprietors. As used herein, the term “registered user” refers to an individual who has established a user account with a database proprietor (e.g., the individual who subscribes to the database proprietor). Database proprietors set cookies and/or other device/user identifiers on the client devices of their registered users to enable the database proprietors to recognize their registered users when their registered users visit website(s) on the Internet domains of the database proprietors.

The protocols of the Internet make cookies inaccessible outside of the domain (e.g., Internet domain, domain name, etc.) on which they were set. Thus, a cookie set in, for example, the YouTube.com domain (e.g., a first party) is accessible to servers in theYouTube.com domain, but not to servers outside that domain. Therefore, although an AME (e.g., a third party) might find it advantageous to access the cookies set by the database proprietors, they are unable to do so. However, techniques have been developed that enable an AME to leverage media impression information collected in association with demographic information in registered user databases of database proprietors to collect more extensive Internet usage (e.g., beyond the limited pool of individuals participating in an AME panel) by extending the impression request process to encompass partnered database proprietors and by using such partners as interim data collectors. In particular, this task is accomplished by structuring the AME to respond to impression requests from clients (who may not be a member of an audience measurement panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received from the AME may cause the client to send a second impression request to the database proprietor along with a cookie set by that database proprietor. In response to receiving this impression request, the database proprietor (e.g., Facebook) can access the cookie it has set on the client to thereby identify the client based on the internal records of the database proprietor.

In the event the client corresponds to a registered user of the database proprietor (as determined from the cookie associated with the client), the database proprietor logs/records a database proprietor demographic impression in association with the client/user. As used herein, a demographic impression is an impression that can be matched to particular demographic information of a particular registered user of the services of a database proprietor. The database proprietor has the demographic information for the particular registered user because the registered user would have provided such information when setting up an account to subscribe to the services of the database proprietor.

Sharing of demographic information associated with registered users of database proprietors enables AMEs to extend or supplement their panel data with substantially reliable demographics information from external sources (e.g., database proprietors), thus extending the coverage, accuracy, and/or completeness of their demographics-based audience measurements. Such access also enables the AME to monitor persons who would not otherwise have joined an AME panel. Any web service provider having a database identifying demographics of a set of individuals may cooperate with the AME. Such web service providers may be referred to as “database proprietors” and include, for example, wireless service carriers, mobile software/service providers, social media sites (e.g., Facebook, Twitter, MySpace, etc.), online retailer sites (e.g., Amazon.com, Buy.com, etc.), multi-service sites (e.g., Yahoo!, Google, Experian, etc.), and/or any other Internet sites that collect demographic data of users and/or otherwise maintain user registration records. The use of demographic information from disparate data sources (e.g., high-quality demographic information from the panels of an audience measurement entity and/or registered user data of database proprietors) results in improved reporting effectiveness of metrics for both online and offline advertising campaigns.

The above approach to generating audience metrics by an AME depends upon the beacon requests (or tags) associated with the media to be monitored to enable an AME to obtain census wide impression counts (e.g., impressions that include the entire population exposed to the media regardless of whether the audience members are panelists of the AME). Further, the above approach also depends on third-party cookies to enable the enrichment of the census impressions with demographic information from database proprietors. However, in more recent years, there has been a movement away from the use of third-party cookies by third parties. Thus, while media providers (e.g., database proprietors) may still use first-party cookies to collect first-party data, the elimination of third-party cookies prevents the tracking of Internet media by AMEs (outside of client devices associated with panelists for which the AME has provided a meter to track Internet usage behavior). Furthermore, independent of the use of cookies, some database proprietors are moving towards the elimination of third party impression requests or tags (e.g., redirect instructions) embedded in media (e.g., beginning in 2020, third-party tags will no longer be allowed on Youtube.com and other Google Video Partner (GVP) sites). As technology moves in this direction, AMEs (e.g., third parties) will no longer be able to track census wide impressions of media in the manner they have in the past. Furthermore, AMEs will no longer be able to send a redirect request to a client accessing media to cause a second impression request to a database proprietor to associate the impression with demographic information. Thus, the only Internet media monitoring that AMEs will be able to directly perform in such a system will be with panelists that have agreed to be monitored using different techniques that do not depend on third-party cookies and/or tags.

Examples disclosed herein overcome at least some of the limitations that arise out of the elimination of third-party cookies and/or third-party tags by enabling the merging of high-quality demographic information from the panels of an AME with media impression data that continues to be collected by database proprietors. As mentioned above, while third-party cookies and/or third-party tags may be eliminated, database proprietors that provide and/or manage the delivery of media accessed online are still able to track impressions of the media (e.g., via first-party cookies and/or first-party tags). Furthermore, database proprietors are still able to associate demographic information with the impressions whenever the impressions can be matched to a particular registered user of the database proprietor for which demographic information has been collected (e.g., when the user registered with the database proprietor). In some examples, the merging of AME panel data and database proprietor impressions data is merged in a privacy-protected cloud environment maintained by the database proprietor.

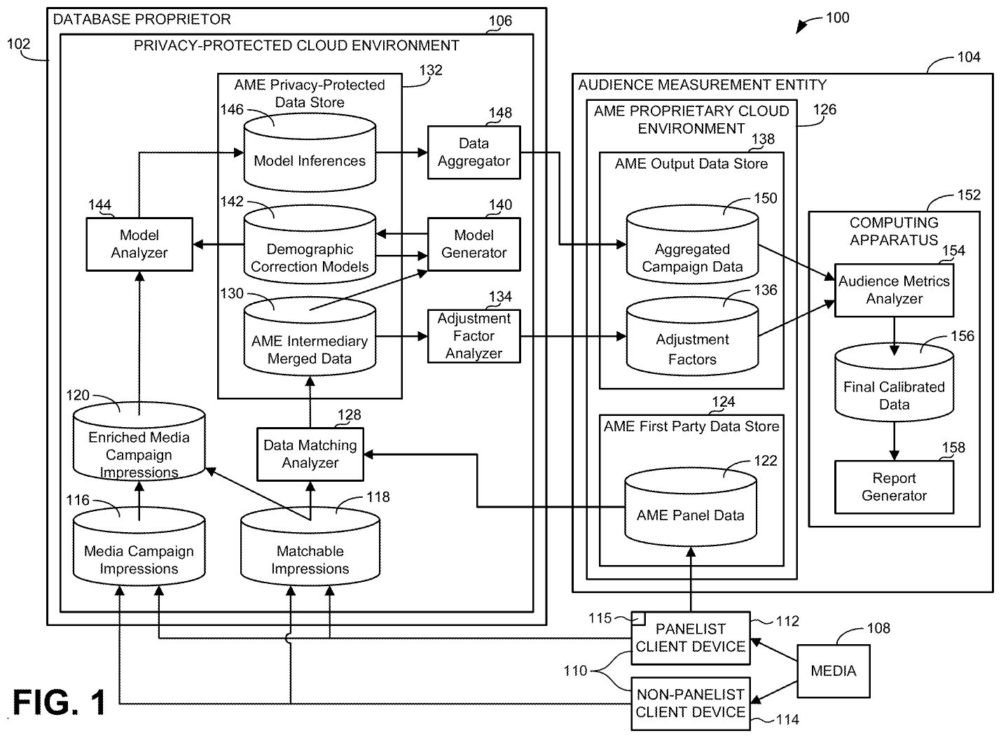

More particularly, FIG. 1 is a block diagram illustrating an example system 100 to enable the generation of audience measurement metrics based on the merging of data collected by a database proprietor 102 and an AME 104. More particularly, in some examples, the data includes AME panel data (that includes media impressions for panelists that are associated with high-quality demographic information collected by the AME 104) and database proprietor impressions data (which may be enriched with demographic and/or other information available to the database proprietor 102). In the illustrated example, these disparate sources of data are combined within a privacy-protected cloud environment 106 managed and/or maintained by the database proprietor 102. The privacy-protected cloud environment 106 is a cloud-based environment that enables media providers (e.g., advertisers and/or content providers) and third parties (e.g., the AME 104) to input and combine their data with data from the database proprietor 102 inside a data warehouse or data store that enables efficient big data analysis. The combining of data from different parties (e.g., different Internet domains) presents risks to the privacy of the data associated with individuals represented by the data from the different parties. Accordingly, the privacy-protected cloud environment 106 is established with privacy constraints that prevent any associated party (including the database proprietor 102) from accessing private information associated with particular individuals. Rather, any data extracted from the privacy-protected cloud environment 106 following a big data analysis and/or query is limited to aggregated information. A specific example of the privacy-protected cloud environment 106 is the Ads Data Hub (ADH) developed by Google.

As used herein, a media impression is defined as an occurrence of access and/or exposure to media 108 (e.g., an advertisement, a movie, a movie trailer, a song, a web page banner, etc.). Examples disclosed herein may be used to monitor for media impressions of any one or more media types (e.g., video, audio, a web page, an image, text, etc.). In examples disclosed herein, the media 108 may be primary content and/or advertisements. Examples disclosed herein are not restricted for use with any particular type of media. On the contrary, examples disclosed herein may be implemented in connection with tracking impressions for media of any type or form in a network.

In the illustrated example of FIG. 1, content providers and/or advertisers distribute the media 108 via the Internet to users that access websites and/or online television services (e.g., web-based TV, Internet protocol TV (IPTV), etc.). For purposes of explanation, examples disclosed herein are described assuming the media 108 is an advertisement that may be provided in connection with particular content of primary interest to a user. In some examples, the media 108 is served by media servers managed by and/or associated with the database proprietor 102 that manages and/or maintains the privacy-protected cloud environment 106. For example, the database proprietor 102 may be Google, and the media 108 corresponds to ads served with videos accessed via Youtube.com and/or via other Google video partners (GVPs). More generally, in some examples, the database proprietor 102 includes corresponding database proprietor servers that can serve media 108 to individuals via client devices 110. In the illustrated example of FIG. 1, the client devices 110 may be stationary or portable computers, handheld computing devices, smart phones, Internet appliances, smart televisions, and/or any other type of device that may be connected to the Internet and capable of presenting media. For purposes of explanation, the client devices 110 of FIG. 1 include panelist client devices 112 and non-panelist client devices 114 to indicate that at least some individuals that access and/or are exposed to the media 108 correspond to panelists who have provided detailed demographic information to the AME 104 and have agreed to enable the AME 104 to track their exposure to the media 108. In many situations, other individuals who are not panelists will also be exposed to the media 108 (e.g., via the non-panelist client devices 114). Typically, the number of non-panelist audience members for a particular media item will be significantly greater than the number of panelist audience members. In some examples, the panelist client devices 112 may include and/or implement an audience measurement meter 115 that captures the impressions of media 108 accessed by the panelist client devices 112 (along with associated information) and reports the same to the AME 104. In some examples, the audience measurement meter 115 may be a separate device from the panelist client device 112 used to access the media 108.

In some examples, the media 108 is associated with a unique impression identifier (e.g., a consumer playback nonce (CPN)) generated by the database proprietor 102. In some examples, the impression identifier serves to uniquely identify a particular impression of the media 108. Thus, even though the same media 108 may be served multiple times, each time the media 108 is served the database proprietor 102 will generate a new and different impression identifier so that each impression of the media 108 can be distinguished from every other impression of the media. In some examples, the impression identifier is encoded into a uniform resource locator (URL) used to access the primary content (e.g., a particular YouTube video) along with which the media 108 (as an advertisement) is served. In some examples, with the impression identifier (e.g., CPN) encoded into the URL associated with the media 108, the audience measurement meter 115 extracts the identifier at the time that a media impression occurs so that the AME 104 is able to associate a captured impression with the impression identifier.

In some examples, the meter 115 may not be able to obtain the impression identifier (e.g., CPN) to associate with a particular media impression. For instance, in some examples where the panelist client device 112 is a mobile device, the meter 115 collects a mobile advertising identifier (MAID) and/or an identifier for advertisers (IDFA) that may be used to uniquely identify client devices 110 (e.g., the panelist client devices 112 being monitored by the AME 104). In some examples, the meter 115 reports the MAID and/or IDFA for the particular device associated with the meter 115 to the AME 104. The AME 104, in turn, provides the MAID and/or IDFA to the database proprietor 102 in a double blind exchange through which the database proprietor 102 provides the AME 104 with the impression identifiers (e.g., CPNs) associated with the client device 110 identified by the MAID and/or IDFA. Once the AME 104 receives the impression identifiers for the client device 110 (e.g., a particular panelist client device 112), the impression identifiers are associated with the impressions previously collected in connection with the device.

In the illustrated example, the database proprietor 102 logs each media impression occurring on any of the client devices 110 within the privacy-protected cloud environment 106. In some examples, logging an impression includes logging the time the impression occurred and the type of client device 110 (e.g., whether a desktop device, a mobile device, a tablet device, etc.) on which the impression occurred. Further, in some examples, impressions are logged along with the impression's unique impression identifier. In this example, the impressions and associated identifiers are logged in a campaign impressions database 116. The campaign impressions database 116 stores all impressions of the media 108 regardless of whether any particular impression was detected from a panelist client device 112 or a non-panelist client device 114. Furthermore, the campaign impressions database 116 stores all impressions of the media 108 regardless of whether the database proprietor 102 is able to match any particular impression to a particular registered user of the database proprietor 102. As mentioned above, in some examples, the database proprietor 102 identifies a particular registered user (e.g., subscriber) associated with a particular media impression based on a cookie stored on the client device 110. In some examples, the database proprietor 102 associates a particular media impression with a registered user that was signed into the online services of the database proprietor 102 at the time the media impression occurred. In some examples, in addition to logging such impressions and associated identifiers in the campaign impressions database 116, the database proprietor 102 separately logs such impressions in a matchable impressions database 118. As used herein, a matchable impression is an impression that the database proprietor 102 is able to match to at least one of a particular registered user (e.g., because the impression occurred on a client device 110 on which a registered user was signed into the database proprietor 102) or a particular client device 110 (e.g., based on a first-party cookie of the database proprietor 102 detected on the client device 110). In some examples, if the database proprietor 102 cannot match a particular media impression (e.g., because no registered user was signed in at the time the media impression occurred and there is no recognizable cookie on the associated client device 110) the impressions is omitted from the matchable impressions database 118 but is still logged in the campaign impressions database 116.

As indicated above, the matchable impressions database 118 includes media impressions (and associated unique impression identifiers) that the database proprietor 102 is able to match to a particular user that has registered with the database proprietor 102. In some examples, the matchable impressions database 118 also includes user-based covariates that correspond to the particular registered user to which each impression in the database was matched. As used herein, a user-based covariate refers to any item(s) of information collected and/or generated by the database proprietor 102 that can be used to identify, characterize, quantify, and/or distinguish particular registered users and/or their associated behavior. For example, user-based covariates may include the name, age, and/or gender of the registered user (and/or any other demographic information about the registered user) collected at the time the registered user registered with the database proprietor 102, and/or the relative frequency with which the registered user uses the different types of client device 110, the number of media items the registered user has accessed during a most recent period of time (e.g., the last 30 days), the search terms entered by the registered user during a most recent period of time (e.g., the last 30 days), feature embeddings (numerical representations) of classifications of videos viewed and/or searches entered by the registered user, etc. As mentioned above, the matchable impressions database 118 also includes impressions matched to particular client devices 110 (based on first-party cookies), even when the impressions cannot be matched to particular registered users (based on the registered users being signed in at the time). In some such examples, the impressions matched to particular client devices 110 are treated as distinct users within the matchable impressions database 118. However, as no particular user can be identified, such impressions in the matchable impressions database 118 will not be associated with any user-based covariates.

Although only one campaign impressions database 116 is shown in the illustrated example, the privacy-protected cloud environment 106 may include any number of campaign impressions databases 116, with each database storing impressions corresponding to different media campaigns associated with one or more different advertisers (e.g., product manufacturers, service providers, retailers, advertisement servers, etc.). In other examples, a single campaign impressions database 116 may store the impressions associated with multiple different campaigns. In some such examples, the campaign impressions database 116 may store a campaign identifier in connection with each impression to identify the particular campaign to which the impression is associated. Similarly, in some examples, the privacy-protected cloud environment 106 may include one or more matchable impressions databases 118 as appropriate. Further, in some examples, the campaign impressions database 116 and the matchable impressions database 118 may be combined and/or represented in a single database.

In the illustrated example of FIG. 1, impressions occurring on the client devices 110 are shown as being reported (e.g., via network communications) directly to both the campaign impressions database 116 and the matchable impressions database 118. However, this should not be interpreted as necessarily requiring multiple separate network communications from the client devices 110 to the database proprietor 102. Rather, in some examples, notifications of impressions are collected from a single network communication from the client device 110, and the database proprietor 102 then populates both the campaign impressions database 116 and the matchable impressions database 118. In some examples, the matchable impressions database 118 is generated based on an analysis of the data in the campaign impressions database 116. Regardless of the particular process by which the two databases 116, 118 are populated with logged impressions, in some examples, the user-based covariates included in the matchable impressions database 118 may be combined with the logged impressions in the campaign impressions database 116 and stored in an enriched impressions database 120. Thus, the enriched impressions database includes all (e.g., census wide) logged impressions of the media 108 for the relevant advertising campaign and also includes all available user-based covariates associated with each of the logged impressions that the database proprietor 102 was able to match to a particular registered user.

As shown in the illustrated example, whereas the database proprietor 102 is able to collect impressions from both panelist client devices 112 and non-panelist client devices 114, the AME 104 is limited to collecting impressions from panelist client devices 112. In some examples, the AME 104 also collects the impression identifier associated with each collected media impression so that the collected impressions may be matched with the impressions collected by the database proprietor 102 as described further below. In the illustrated example, the impressions (and associated impression identifiers) of the panelists are stored in an AME panel data database 122 that is within an AME first party data store 124 in an AME proprietary cloud environment 126. In some examples, the AME proprietary cloud environment 126 is a cloud-based storage system (e.g., a Google Cloud Project) provided by the database proprietor 102 that includes functionality to enable interfacing with the privacy-protected cloud environment 106 also maintained by the database proprietor 102. As mentioned above, the privacy-protected cloud environment 106 is governed by privacy constraints that prevent any party (with some limited exceptions for the database proprietor 102) from accessing private information associated with particular individuals. By contrast, the AME proprietary cloud environment 126 is indicated as proprietary because it is exclusively controlled by the AME such that the AME has full control and access to the data without limitation. While some examples involve the AME proprietary cloud environment 126 being a cloud-based system that is provided by the database proprietor 102, in other examples, the AME proprietary cloud environment 126 may be provided by a third party distinct from the database proprietor 102.

While the AME 104 is limited to collected impressions (and associated identifiers) from only panelists (e.g., via the panelist client devices 112), the AME 104 is able to collect panel data that is much more robust than merely media impressions. As mentioned above, the panelist client devices 112 are associated with users that have agreed to participate on a panel of the AME 104. Participation in a panel includes the provision of detailed demographic information about the panelist and/or all members in the panelist's household. Such demographic information may include age, gender, race, ethnicity, education, employment status, income level, geographic location of residence, etc. In addition to such demographic information, which may be collected at the time a user enrolls as a panelist, the panelist may also agree to enable the AME 104 to track and/or monitor various aspects of the user's behavior. For example, the AME 104 may monitor panelists' Internet usage behavior including the frequency of Internet usage, the times of day of such usage, the websites visited, and the media exposed to (from which the media impressions are collected).

AME panel data (including media impressions and associated identifiers, demographic information, and Internet usage data) is shown in FIG. 1 as being provided directly to the AME panel data database 122 from the panelist client devices 112. However, in some examples, there may be one or more intervening operations and/or components that collect and/or process the collected data before it is stored in the AME panel data database 122. For instance, in some examples, impressions are initially collected and reported to a separate server and/or database that is distinct from the AME proprietary cloud environment 126. In some such examples, this separate server and/or database may not be a cloud-based system. Further, in some examples, such a non-cloud-based system may interface directly with the privacy-protected cloud environment 106 such that the AME proprietary cloud environment 126 may be omitted entirely.

In some examples, there may be multiple different techniques and/or methodologies used to collect the AME panel data that depends on the particular circumstances involved. For example, different monitoring techniques and/or different types of audience measurement meters 115 may be employed for media accessed via a desktop computer relative to the media accessed via a mobile computing device. In some examples, the audience measurement meter 115 may be implemented as a software application that panelists agree to install on their devices to monitor all Internet usage activity on the respective devices. In some examples, the meter 115 may prompt a user of a particular device to identify themselves so that the AME 104 can confirm the identity of the user (e.g., whether it was the mother or daughter in a panelist household). In some examples, prompting a user to self-identify may be considered overly intrusive. Accordingly, in some such examples, the circumstances surrounding the behavior of the user of a panelist client device 112 (e.g., time of day, type of content being accessed, etc.) may be analyzed to infer the identity of the user to some confidence level (e.g., the accessing of children's content in the early afternoon would indicate a relatively high probability that a child is using the device at that point in time). In some examples, the audience measurement meter 115 may be a separate hardware device that is in communication with a particular panelist client device 112 and enabled to monitor the Internet usage of the panelist client device 112.

In some examples, the processes and/or techniques used by the AME 104 to capture panel data (including media impressions and who in particular was exposed to the media) can differ depending on the nature of the panelist client device 112 through which the media was accessed. For instance, in some examples, the identity of the individual using the panelist client device 112 may be based on the individual responding to a prompt to self-identify. In some examples, such prompts are limited to desktop client devices because such a prompt is viewed as overly intrusive on a mobile device. However, without specifically prompting a user of a mobile device to self-identify, there often is no direct way to determine whether the user is the primary user of the device (e.g., the owner of the device) or someone else (e.g., a child of the primary user). Thus, there is the possibility of misattribution of media impressions within the panel data collected using mobile devices. In some examples, to overcome the issue of misattribution in the panel data, the AME 104 may develop a machine learning model that can predict the true user of a mobile device (or any device for that matter) based on information that the AME 104 does know for certain and/or has access to. For example, inputs to the machine learning model may include the composition of the panelist household, the type (e.g., genre and/or category) of the content, the daypart or time of day when the content was accessed, etc. In some examples, the truth data used to generate and validate such a model may be collected through field surveys in which the above input features are tracked and/or monitored for a subset of panelists that have agreed to be monitored in this manner (which is more intrusive than the typical passive monitoring of content accessed via mobile devices).

As mentioned above, in some examples, the AME panel data (stored in the AME panel data database 122) is merged with the database proprietor impressions data (stored in the matchable impressions database 118) within the privacy-protected cloud environment 106 to take advantage of the combination of the disparate sets of data to generate more robust and/or reliable audience measurement metrics. In particular, the database proprietor impressions data provides the advantage of volume. That is, the database proprietor impressions data corresponds to a much larger number of impressions than the AME panel data because the database proprietor impressions data includes census wide impression information that includes all impressions collected from both the panelist client devices 112 (associated with a relatively small pool of audience members) and the non-panelist client devices 114. The AME panel data provides the advantage of high-quality demographic data for a statistically significant pool of audience members (e.g., panelists) that may be used to correct for errors and/or biases in the database proprietor impressions data.

One source of error in the database proprietor impressions data is that the demographic information for matchable users collected by the database proprietor 102 during user registration may not be truthful. In particular, in some examples, many database proprietors impose age restrictions on their user accounts (e.g., a user must be at least 13 years of age, at least 18 years of age to register with the database proprietor 102, etc.). However, when a person registers with the database proprietor 102, the person typically self-declares their age and may, therefore, lie about their age (e.g., an 11 year old may say they are 18 to bypass the age restrictions for a user account). Independent of age restrictions, a particular user may choose to enter an incorrect age for any other reason or no reason at all when registering with the database proprietor 102 (e.g., a 44 year old may choose to assert they are only 25). Where a database proprietor 102 does not verify the self-declared age of registered users, there is a relatively high likelihood that the ages of at least some registered users of the database proprietor stored in the matchable impressions database 118 (as a particular user-based covariate) are inaccurate. Further, it is possible that other self-declared demographic information (e.g., gender, race, ethnicity, income level, etc.) may also be falsified by users during registration.

As described further below, the AME panel data (which contains reliable demographic information about the panelists) can be used to correct for inaccurate demographic information in the database proprietor impressions data. Additionally, while the self-declared age of a particular registered user may be truthful and accurate, a different person of a different age may end up using a client device 110 on which the particular registered user is logged into the user account. For example, a child my access media on a client device 110 in which a parent of the child is logged into a user account of the database proprietor 102. As a result, media accessed by the child would be misattributed to the demographics (e.g., the self-declared age) of the parent.

Thus, even when self-declared demographic information is true, it may nevertheless be wrong with respect to the demographic characteristics of the person actually using the user account at any given point in time. This scenario is more common for client devices and/or user accounts that are used and/or shared by multiple different people (e.g., different members in a single household). As used herein, the term “shared user account” refers to a user account that is used by more than one panelist. As such, shared user accounts include user accounts that are intended to be shared by multiple individuals as well as user accounts that, as a matter of happenstance, are used by multiple individuals (e.g., a child inadvertently remains logged into their parent's user account after the parent used the same computer).

Another source of error in the database proprietor impressions data is based on the concept of misattribution, which arises in situations where multiple different people use the same client device 110 to access media. In some examples, the database proprietor 102 associates a particular impression to a particular registered user based on the registered user being signed into a platform provided by the database proprietor 102. For example, if a particular person signs into their Google account and begins watching a YouTube video on a particular client device 110, that person will be attributed with an impression for an ad served during the video because the person was signed in at the time. However, there may be instances where the person finishes using the client device 110 but does not sign out of his or her Google account. Thereafter, a second different person (e.g., a different member in the family of the first person) begins using the client device 110 to view another YouTube video. Although the second person is now accessing media via the client device 110, ad impressions during this time will still be attributed to the first person because the first person is the one who is still indicated as being signed in (e.g., the user account of the first person has become a shared user account). Thus, there is likely to be circumstances where the actual person exposed to media 108 is misattributed to a different registered user of the database proprietor 102 and/or an unregistered user. The AME panel data (which includes an indication of the actual person using the panelist client devices 112 at any given moment) can be used to correct for misattribution in the demographic information in the database proprietor impressions data. As mentioned above, in some situations, the AME panel data may itself include misattribution errors. Accordingly, in some examples, the AME panel data may first be corrected for misattribution before the AME panel data is used to correct misattribution in the database proprietor impressions data. An example methodology to correct for misattribution in the database proprietor impressions data is described in Singh et al., U.S. Pat. No. 10,469,903, which is hereby incorporated herein by reference in its entirety.

Misattribution can also occur where there are multiple shared user accounts on the same device. For example, a parent may log into his or her user account and forget to log out after using a communal desktop computer. Subsequently, a child may use the computer for a time before realizing that the parent's user account is logged in. Upon realization that the parent's user account is logged in, the child may log out of the parent's user account, and log into the child's user account. After the child completes use of the communal desktop computer, he or she may forget to log out. Subsequently, the child's brother or sister may use the communal family computer without realizing that the child's user account is logged in. Accordingly, when multiple shared user accounts are present in a panelist household, self-declared demographic information may be wrong with respect to the demographic characteristics of the person actually using the user account at any given point in time for multiple accounts. Here, as described above, the AME panel data (which includes an indication of the actual person using the panelist client devices 112 at any given moment) can be used to correct for misattribution in the demographic information in the database proprietor impressions data.

Another problem with the database proprietor impressions data is that of non-coverage. Non-coverage refers to impressions recorded by the database proprietor 102 that cannot be matched to a particular registered user of the database proprietor 102. The inability of the database proprietor 102 to match a particular impression to a particular user can occur for several reasons including that the registered user is not signed in at the time of the media impression, that the user has not established an account with the database proprietor 102, that the registered user has enabled Limited Ad Tracking (LAT) to prevent the user account from being associated with ad impressions, or that the content associated with the media being monitored corresponds to children's content (for which user-based tracking is not performed). While the inability of the database proprietor 102 to match and assign a particular impression to a particular registered user is not necessarily an error in the database proprietor impressions data, it does undermine the ability to reliably estimate the total unique audience size for (e.g., the number of unique individuals that were exposed to) a particular media item. For example, assume that the database proprietor 102 records a total of 11,000 impressions for media 108 in a particular advertising campaign. Further assume that of those 11,000 impressions, the database proprietor 102 is able to match 10,000 impressions to a total of 5,000 different users (e.g., each user was exposed to the media on average 2 times) but is unable to match the remaining 1,000 impressions to particular users. Relying solely on the database proprietor impressions data, in this example, there is no way to determine whether the remaining 1,000 impressions should also be attributed to the 5,000 users already exposed at least once to the media 108 (for a total audience size of 5,000 people) or if one or more of the remaining 1,000 impressions should be attributed to other users not among the 5,000 already identified (for a total audience size of up to 6,000 people (if every one of the 1,000 impressions was associated with a different person not included in the matched 5,000 users)). In some examples disclosed herein, the AME panel data can be used to estimate the distribution of impressions across different users associated with the non-coverage portion of impressions in the database proprietor impressions data to thereby estimate a total audience size for the relevant media 108.

Another confounding factor to the estimation of the total unique audience size for media based on the database proprietor impressions data is the existence of multiple user accounts of a single registered user. More particular, in some situations a particular individual may establish multiple accounts with the database proprietor 102 for different purposes (e.g., a personal account, a work account, a shared user account, etc.). Such a situation can result in a larger number of different users being identified as audience members to media 108 than the actual number of individuals exposed to the media 108. For example, assume that a particular person registers three user accounts with the database proprietor 102 and is exposed to the media 108 once while signed into each of the three different accounts for a total of three impressions. In this scenario, the database proprietor 102 would match each impression to a different registered user based on the different user accounts making it appear that three different people were exposed to the media 108 when, in fact, only one person was exposed to the media three different times. Examples disclosed herein use the AME panel data in conjunction with the database proprietor impressions data to estimate an actual unique audience size from the potentially inflated number of apparently unique users exposed to the media 108.

In the illustrated example of FIG. 1, the AME panel data is merged with the database proprietor impressions data by an example data matching analyzer 128. In some examples, the data matching analyzer 128 implements an application programming interface (API) that takes the disparate datasets and matches registered users in the database proprietor impressions data with panelists in the AME panel data. In some examples, registered users are matched with panelists based on the unique impression identifiers (e.g., CPNs) collected in connection with the media impressions logged by both the database proprietor 102 and the AME 104. The combined data is stored in an AME intermediary merged data database 130 within an AME privacy-protected data store 132. The data in the AME intermediary merged data database 130 is referred to as “intermediary” because it is at an intermediate stage in the processing because it includes AME panel data that has been enhanced and/or combined with the database proprietor impressions data, but has not yet been corrected or adjusted to account for the sources of error and/or bias in the database proprietor impressions data as outlined above.

In some examples, the AME intermediary merged data is analyzed by an adjustment factor analyzer 134 to calculate adjustment or calibration factors that may be stored in an adjustment factors database 136 within an AME output data store 138 of the AME proprietary cloud environment 126. In some examples, the adjustment factor analyzer 134 calculates different types of adjustment factors to account for different types of errors and/or biases in the database proprietor impressions data. For instance, a multi-account adjustment factor corrects for the situation of a single registered user accessing media using multiple different user accounts associated with the database proprietor 102. A signed-out adjustment factor corrects for non-coverage associated with registered users that access media while signed out of their account associated with the database proprietor 102 (so that the database proprietor 102 is unable to associate the impression with the registered users). In some examples, the adjustment factor analyzer 134 is able to directly calculate the multi-account adjustment factor and the signed-out adjustment factor in a deterministic manner.

While the multi-account adjustment factors and the signed-out adjustment factors may be deterministically calculated, correcting for falsified or otherwise incorrect demographic information (e.g., incorrectly self-declared ages) of registered users of the database proprietor 102 cannot be solved in such a direct and deterministic manner. Rather, in some examples, a machine learning model is developed to analyze and predict the correct ages of registered users of the database proprietor 102. Specifically, as shown in FIG. 1, the privacy-protected cloud environment 106 implements a model generator 140 to generate a demographic correction model using the AME intermediary merged data (stored in the AME intermediary merged data database 130) as inputs.

More particularly, in some examples, self-declared demographics (e.g., the self-declared age) of registered users of the database proprietor 102, along with other covariates associated with the registered users, are used as the input variables or features used to train a model to predict the correct demographics (e.g., correct age) of the registered users as validated by the AME panel data, which serves as the truth data or training labels for the demographic correction model generation. However, in some examples, the self-declared age or other demographics of a registered user signed into a user account on a panelist client device 112 may not match the age or other demographics of the primary user of the user account.

As used herein, the term “primary user of a user account” refers to an individual whose demographic information an AME should attribute to a user account based on a primary user identification algorithm. While in some instances identifying the primary user of a user account may be straightforward (e.g., when a user account is used by only one person), in other cases the identity of the primary user of a user account is not as forthcoming (e.g., when multiple people use the same user account). For example, a parent that buys a computer for a child may log into the computer with the parent's user account with the database proprietor 102 despite the child being the primary user of the parent's user account. Thus, because the registered user of a user account is not always the primary user of the user account, in some examples (e.g., in the case of a shared user account), merely relying on the demographics of the registered user may be insufficient to accurately monitor the demographics of the person exposed to media. By identifying the primary user of the user account, examples disclosed herein determine the demographics of the person that accessed media. Therefore, examples disclosed herein generate reliable demographics and/or other covariates associated with the registered users to train models to predict correct demographics.

In some examples, different demographic correction model(s) may be developed to correct for different types of demographic information that needs correcting. For instance, in some examples, a first model can be used to correct the self-declared age of registered users of the database proprietor 102 and a second model can be used to correct the self-declared gender of the registered users. Once the model(s) have been trained and validated based on the AME panel data, the model(s) are stored in a demographic correction models database 142.

As mentioned above, there are many different types of covariates collected and/or generated by the database proprietor 102. In some examples, the covariates provided by the database proprietor 102 may include a certain number (e.g., 100) of the top search result click entities and/or video watch entities for every user during a most recent period of time (e.g., for the last month). These entities are integer identifiers (IDs) that map to a knowledge graph of all entities for the search result clicks and/or videos watched. That is, as used in this context, an entity corresponds to a particular node in a knowledge graph maintained by the database proprietor 102. In some examples, the total number of unique IDs in the knowledge graph may number in the tens of millions. More particularly, for example, YouTube videos are classified across roughly 20 million unique video entity IDs and Google search results are classified across roughly 25 million unique search result entity IDs. In addition to the top search result click entities and/or video watch entities, the database proprietor 102 may also provide embeddings for these entities. An embedding is a numerical representation (e.g., a vector array of values) of some class of similar objects, images, words, and the like. For example, a particular user that frequently searches for and/or views cat videos may be associated with a feature embedding representative of the class corresponding to cats. Thus, feature embeddings translate relatively high dimensional vectors of information (e.g., text strings, images, videos, etc.) into a lower dimensional space to enable the classification of different but similar objects.

In some examples, multiple embeddings may be associated with each search result click entity and/or video watch entity. Accordingly, assuming the top 100 search result entities and video watch entities are provided among the covariates and that 16 dimension embeddings are provided for each such entity, this results in a 100×16 matrix of values for every user, which may be too much data to process during generation of the demographic correction models as described above. Accordingly, in some examples, the dimensionality of the matrix is reduced to a more manageable size to be used as an input feature for the demographic correction model generation.

In some examples, a process is implemented to track different demographic correction model experiments over time to achieve high quality (e.g., accurate) models and also for auditing purposes. Accomplishing this objective within the context of the privacy-protected cloud environment 106 presents several unique challenges because the model features (e.g., inputs and hyperparameters) and model performance (e.g., accuracy) are stored separately to satisfy the privacy constraints of the environment.

In some examples, a model analyzer 144 may implement and/or use one or more demographic correction models to generate predictions and/or inferences as to the actual demographics (e.g., actual ages) of registered users associated with media impressions logged by the database proprietor 102. That is, in some examples, as shown in FIG. 1, the model analyzer 144 uses one or more of the demographic correction models in the demographic correction models database 142 to analyze the impressions in the enriched impressions database 120 that were matched to a particular registered user of the database proprietor 102. The inferred demographic (e.g., age) for each registered user may be stored in a model inferences database 146 for subsequent use, retrieval, and/or analysis. Additionally or alternatively, in some examples, the model analyzer 144 uses one or more of the demographic correction models in the demographic correction models database 142 to analyze the entire registered user base of the database proprietor regardless of whether the registered users are matched to any particular media impressions. After inferring the correct demographic (e.g., age) for each registered user, the inferences are stored in the model inferences database 146. In some such examples, when the registered users matched to particular impressions are to be analyzed (e.g., the registered users matched to impressions in the enriched impressions database 120), the model analyzer 144 merely extracts the inferred demographic assignment to each relevant registered user in the enriched impressions database 120 that matches with one or more media impressions.

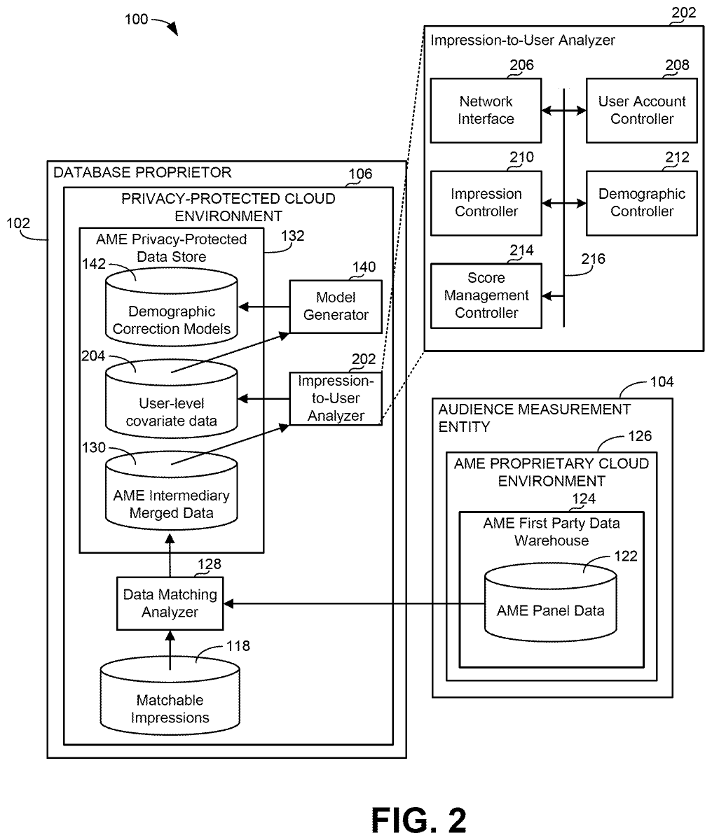

As described above, in some examples, the database proprietor 102 may identify a particular registered user as corresponding to a particular impression based on the registered user being signed into the database proprietor 102. However, there are circumstances where the individual corresponding to the user account is not the actual person that was exposed to the relevant media. Accordingly, merely inferring a correct demographic (e.g., age) of the registered user associated with the signed in user account may not be the correct demographic of the actual person to which a particular media impression should be attributed. In other words, whereas the AME panelist data and the database proprietor impressions data is matched at the impression level, demographic correction is implemented at the user level. Therefore, before generating the demographic correction model, a method to reduce logged impressions to individual users is first implemented so that the demographic correction model can be reliably implemented. In particular, as shown in the illustrated example of FIG. 2, instead of using the AME intermediary merged data directly as an input to the model generator 140, in some examples, an impression-to-user analyzer 202 is implemented to generate user-level covariate data from the AME intermediary merged data by executing a primary user identification algorithm.

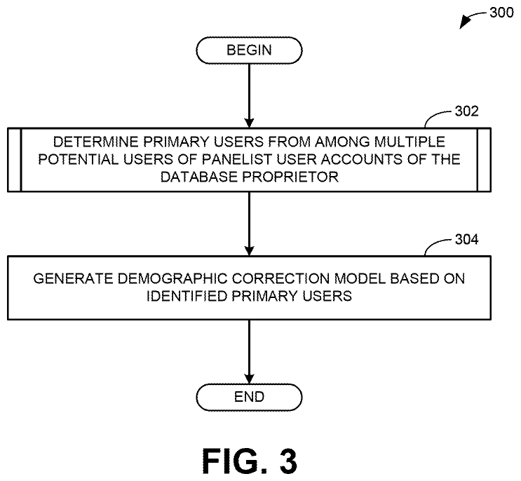

FIG. 2 illustrates the example system 100 of FIG. 1 with certain portions omitted for the sake of clarity and additional portions shown as described further below. In some examples, the user-level covariate data is stored within a user-level covariate data database 204 within the AME privacy-protected data store 132 and provided as an input to the model generator 140. In some examples, the impression-to-user analyzer 202 and the model generator 140 may be incorporated together and implemented in combination. Example processes to implement the example impression-to-user analyzer 202 of FIG. 2 are represented by the flowcharts in FIGS. 3, 4, and 5.

In the illustrated example of FIG. 2, the model generator 140 is implemented by processor circuitry (e.g., one or more processors, one or more accelerators, etc.) executing instructions. In the example of FIG. 2, the model generator 140 executes a training algorithm (e.g., stochastic gradient descent) to train one or more demographic correction models to operate in accordance with patterns and/or associations based on, for example, training data (e.g., the user-level covariate data from the AME intermediary merged data). In general, the one or more demographic correction models include internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

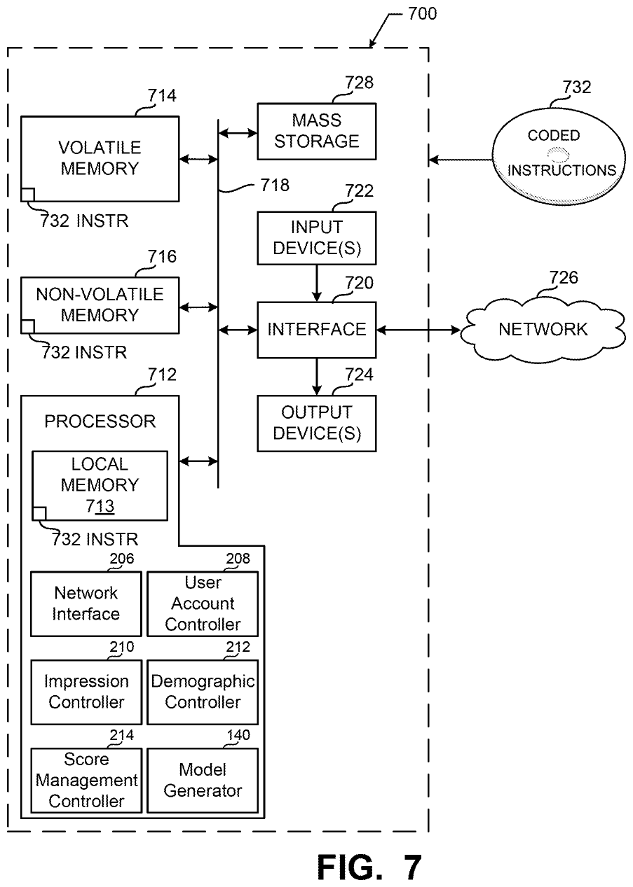

In some examples, the example model generator 140 implements example means for generating models. The means for generating models is implemented by executable instructions such as that implemented by at least block 304 of FIG. 3. The executable instructions of block 304 of FIG. 3 may be executed on at least one processor such as the example processor 712 of FIG. 7. In other examples, the means for generating models is implemented by hardware logic, hardware implemented state machines, logic circuitry, and/or any other combination of hardware, software, and/or firmware.

In the illustrated example of FIG. 2, the impression-to-user analyzer 202 is implemented by processor circuitry (e.g., one or more processors, one or more accelerators, etc.) executing instructions. In the example of FIG. 2, the impression-to-user analyzer 202 includes an example network interface 206, an example user account controller 208, an example impression controller 210, an example demographic controller 212, and an example score management controller 214. In the example of FIG. 2, any of the network interface 206, the user account controller 208, the impression controller 210, the demographic controller 212, and/or the score management controller 214 can communicate via an example communication bus 216.

In examples disclosed herein, the communication bus 216 may be implemented using any suitable wired and/or wireless communication. In additional or alternative examples, the communication bus 216 includes software, machine readable instructions, and/or communication protocols by which information is communicated among the network interface 206, the user account controller 208, the impression controller 210, the demographic controller 212, and/or the score management controller 214.

In the illustrated example of FIG. 2, the impression-to-user analyzer 202 determines the primary user from among multiple potential users of one or more user accounts of the database proprietor 102. As described above, it is not uncommon for multiple different people (e.g., different members in a single household) to use a user account. For instance, different members in a household may use a common computing device in which a single person (e.g., a single registered user) remains logged in to a user account of the database proprietor 102 while multiple different people use the computer. For example, a first member of the household may log in to the user account of database proprietor 102 for the first member on the computer and then stop using the computer without logging out. Thereafter, a second member of the household may begin using the computer while the first member is still logged in to the user account of the database proprietor 102.

In some examples, the second member of the household may use the computer far more often than the first member of the household. In such examples, the demographics of the second member of the household may not match the demographics of the registered user (e.g., the first member of the household). In some such examples, the impression-to-user analyzer 202 may determine that the second member of the household is the primary user of the account (e.g., based on the primary user identification algorithm disclosed herein) even though the first member created the account in his or her own name and included demographics information (e.g., a self-declared age) for himself or herself. With the primary user identified, the impression-to-user analyzer 202 adjusts demographic information of user accounts to reflect the primary users of the user accounts.

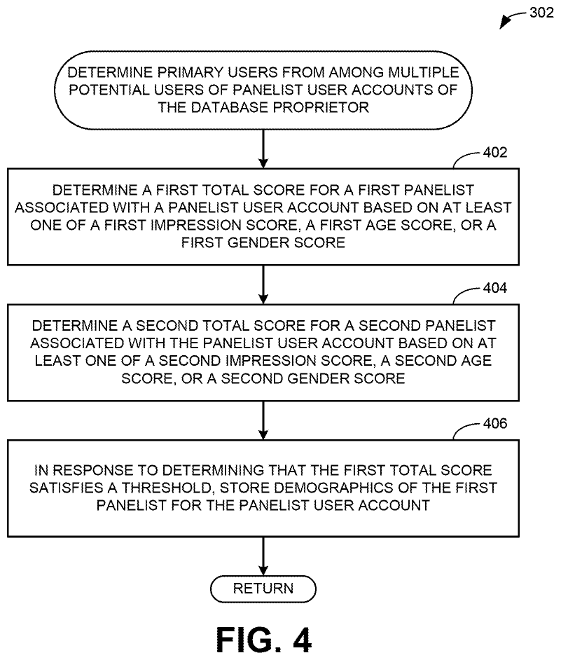

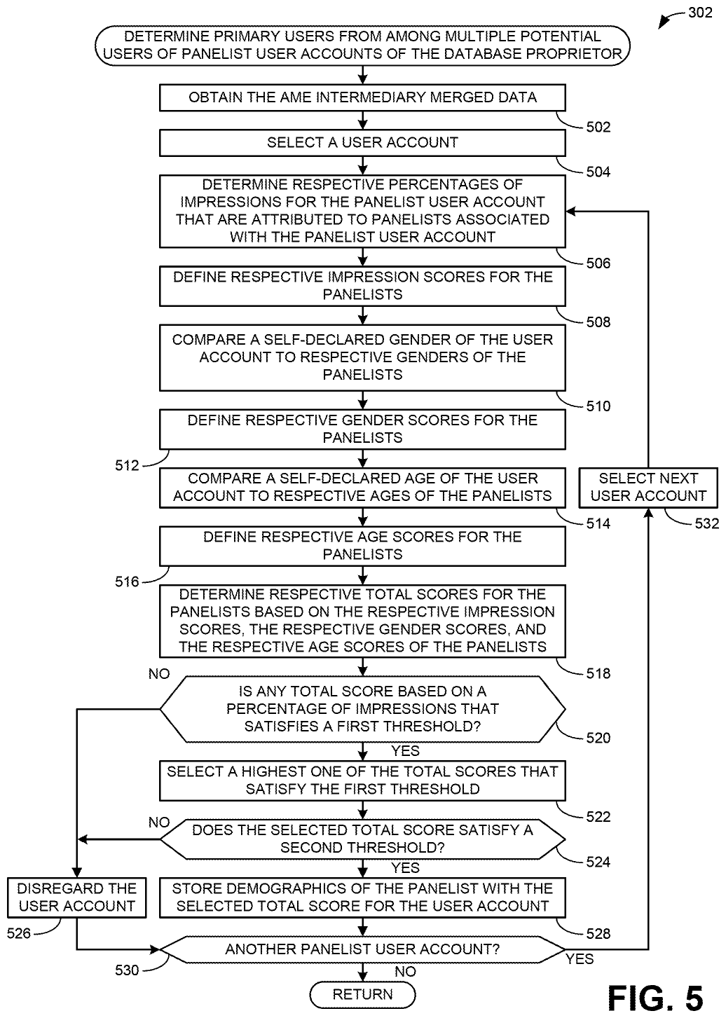

In some examples, the example impression-to-user analyzer 202 implements example means for adjusting demographics. The means for adjusting demographics is implemented by executable instructions such as that implemented by at least block 302 of FIG. 3; at least blocks 402, 404, and 406 of FIG. 4; and/or at least blocks 502, 504, 506, 508, 510, 512, 514, 516, 518, 520, 522, 524, 526, 528, 530, and 532 of FIG. 5. The executable instructions of block 302 of FIG. 3; blocks 402, 404, and 406 of FIG. 4; and/or blocks 502, 504, 506, 508, 510, 512, 514, 516, 518, 520, 522, 524, 526, 528, 530, and 532 of FIG. 5 may be executed on at least one processor such as the example processor 712 of FIG. 7. In other examples, the means for adjusting demographics is implemented by hardware logic, hardware implemented state machines, logic circuitry, and/or any other combination of hardware, software, and/or firmware.

In the illustrated example of FIG. 2, the network interface 206 is implemented by processor circuitry executing instructions. For example, the network interface 206 may be implemented by a network interface controller. In additional or alternative examples, the network interface 206 can be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

In the illustrated example of FIG. 2, the network interface 206 obtains the AME intermediary merged data (stored in the AME intermediary merged data database 130). After obtaining the AME intermediary merged data, the network interface 206 forwards the AME intermediary merged data to the user account controller 208, the impression controller 210, the demographic controller 212, and/or the score management controller 214. Additionally, after the impression-to-user analyzer 202 determines the primary user of a user account of the database proprietor 102 from among other potential users of the user account, the network interface 206 associates the primary user (and their demographics) with the user account. For examples, the network interface 206 stores the demographics of the primary user for the user account (e.g., in the user-level covariate data database 204).

In some examples, the example network interface 206 implements example means for interfacing. The means for interfacing is implemented by executable instructions such as that implemented by at least block 406 of FIG. 4 and/or at least blocks 502 and 528 of FIG. 5. The executable instructions of block 406 of FIG. 4 and/or blocks 502 and 528 of FIG. 5 may be executed on at least one processor such as the example processor 712 of FIG. 7. In other examples, the means for interfacing is implemented by hardware logic, hardware implemented state machines, logic circuitry, and/or any other combination of hardware, software, and/or firmware.

In the illustrated example of FIG. 2, the user account controller 208 is implemented by processor circuitry executing instructions. In additional or alternative examples, the user account controller 208 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the user account controller 208 selects user accounts to be analyzed by the impression-to-user analyzer 202. For example, the user account controller 208 identifies a user account represented in the AME panel data included within the AME intermediary merged data. Example AME panel data is collected by device type. For example, a first panel may monitor panelist use of a desktop or laptop computer while a second panel may monitor panelist use of a tablet or smart phone. However, examples disclosed herein are not limited to a panel collected for a single device. On the contrary, examples disclosed herein can determine the primary user of a user account that is logged in on multiple devices of different types (e.g., a cell phone and a laptop) and/or a user account that is logged in on multiple devices of the same type (e.g., multiple desktop computers).

In the illustrated example of FIG. 2, the identified user account may be associated with a panelist household including more than one panelist. In this manner, the identified user account is associated with one or more panelists. As such, the identified user may be a shared user account for which the registered user is not necessarily the primary user. After selecting a user account, the user account controller 208 forwards an identifier of the selected user account to the impression controller 210, the demographic controller 212, and/or the score management controller 214.

As described above, in some examples, the data matching analyzer 128 matches user accounts of the database proprietor 102 with AME panelists based on the unique impression identifiers (e.g., CPNs) collected in connection with the media impressions logged by both the database proprietor 102 and the AME 104. For example, as permitted by the laws and/or regulations of the geographic location of registered users and/or panelists, the data matching analyzer 128 may utilize the AME panel data such as a panelist's name, a panelist's location, among others, to compare against similar fields provided by the database proprietor 102. If the data matching analyzer 128 determines that the AME panel data matches similar data provided by the database proprietor 102, the data matching analyzer 128 obtains the impression identifier (e.g., a CPN) associated with each impression experienced by an individual logged in to the user account (e.g., the registered user). In this manner, the data matching analyzer 128 maps the data associated with the impression identifier to the AME panel data.

In some examples, the example user account controller 208 implements example means for managing user accounts. The means for managing user accounts is implemented by executable instructions such as that implemented by at least blocks 504, 530, and 532 of FIG. 5. The executable instructions of blocks 504, 530, and 532 of FIG. 5 may be executed on at least one processor such as the example processor 712 of FIG. 7. In other examples, the means for managing user accounts is implemented by hardware logic, hardware implemented state machines, logic circuitry, and/or any other combination of hardware, software, and/or firmware.

In the illustrated example of FIG. 2, the impression controller 210 is implemented by processor circuitry executing instructions. In additional or alternative examples, the impression controller 210 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the impression controller 210 determines respective percentages of impressions for the selected user account that have been attributed to one or more panelists associated with the selected user account.

For example, the percentages indicate the proportion of impressions logged for the selected user account that were actually experienced by each panelist associated with the selected user account. For example, for a shared user account, 30% of the impressions associated with the shared user account may be experienced by a first parent in a household (e.g., a father), 10% of the impressions associated with the shared user account may be experienced by a second parent in the household (e.g., a mother), and 60% of the impressions associated with the shared user account may be experienced by a child in the household.

In the illustrated example of FIG. 2, the impression controller 210 determines which panelist experienced an impression based on different criteria associated with the type of client device on which the panelist experienced the impression. For example, if the client device is a desktop client device, the impression controller 210 determines which panelist experienced the impression based on the response to a prompt to self-identify. Alternatively, as mentioned above, for mobile client devices, such a prompt is typically viewed as overly intrusive. Accordingly, for many mobile client devices, the impression controller 210 attributes 100% of the impressions logged for the selected user account to the panelist registered to the mobile client device, based on the AME panel data.

In the illustrated example of FIG. 2, the impression controller 210 determines respective impression scores for the panelists associated with the selected user account. For example, the impression controller 210 determines the impression score for each panelist based on the percentage of impression attributed to each panelist. For example, if between 60% and 80% of the impressions associated with the selected user account (e.g., selected shared user account) are attributed to a first panelist, the impression controller 210 assigns an impression score of four out of five (e.g., 4/5) for the first panelist. In additional or alternative examples, different scales for scoring may be used. After determining the respective impression scores for the panelists, the impression controller 210 forwards the respective impression scores and associated impression percentages to the score management controller 214.

In some examples, the example impression controller 210 implements example means for managing impressions. The means for managing impressions is implemented by executable instructions such as that implemented by at least blocks 506 and 508 of FIG. 5. The executable instructions of blocks 506 and 508 of FIG. 5 may be executed on at least one processor such as the example processor 712 of FIG. 7. In other examples, the means for managing impressions is implemented by hardware logic, hardware implemented state machines, logic circuitry, and/or any other combination of hardware, software, and/or firmware.

In the illustrated example of FIG. 2, the demographic controller 212 is implemented by processor circuitry executing instructions. In additional or alternative examples, the demographic controller 212 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the demographic controller 212 determines respective gender scores and respective age scores for the panelists associated with the selected user account.

For example, the demographic controller 212 compares the self-declared gender of the selected user account (indicated in the database proprietor impressions data) to respective genders of the panelists associated with the selected user account (e.g., as indicated from the AME panel data). Based on the comparison, the demographic controller 212 defines respective gender scores for the panelists. In some examples, if the self-declared gender of the selected user account matches the gender of a first panelist associated with the selected user account (e.g., indicated from the AME panel data), the demographic controller 212 defines a full gender score (e.g., 5/5) for the first panelist. In some examples, if the self-declared gender of the selected user account is not stated or undetermined, the demographic controller 212 defines a zero gender score (e.g., 0/5) for the first panelist. In additional or alternative examples, different scales for scoring may be used.

In some examples, the self-declared gender of the selected user account may be nonbinary. In such examples, the self-declared gender of the selected user account will not match the gender of any panelist because the AME panel data is collected on a binary scale (e.g., male or female). In such examples, if the self-declared gender of the selected user account is non-binary and does not match the gender of the first panelist indicated from the AME panel data, the demographic controller 212 assigns a zero gender score (e.g., 0/5) for the first panelist. In additional or alternative examples, different scales for scoring may be used.

In some examples, the self-declared gender of the selected user account may conflict with the gender of a panelist indicated from the AME panel data. For example, if the self-declared gender of the selected user account is male and the gender of a first panelist associated with the selected user account is female (as indicated from the AME panel data), the demographic controller 212 assigns a negative gender score (e.g., −5/5) for the first panelist. In additional or alternative examples, different scales for scoring may be used. For example, the gender scores could be scaled to include only positive and zero values.

In the illustrated example of FIG. 2, the demographic controller 212 compares the self-declared age of the selected user account (indicated in the database proprietor impressions data) to respective ages of the panelists associated with the selected user account (e.g., as indicated from the AME panel data). Based on the comparison, the demographic controller 212 defines respective age scores for the panelists associated with the selected user account. For example, the demographic controller 212 determines a difference between the self-declared age of the selected user account and the age of a first panelist indicated from the AME panel data. In some examples, for smaller differences between the self-declared age of the selected user account and the ages of the panelists, the demographic controller 212 assigns higher age scores for the panelists. For example, if the self-declared age of the selected user account is 25 and the age of a first panelist is 25 (as indicated from the AME panel data), the demographic controller 212 assigns a full age score (e.g., 5/5) for the first panelist. After determining the respective gender scores and the respective age scores for the panelists associated with the selected user account, the demographic controller 212 forwards the respective gender scores and the respective age scores to the score management controller 214.

In some examples, the example demographic controller 212 implements example means for managing demographics. The means for managing demographics is implemented by executable instructions such as that implemented by at least blocks 510, 512, 514, and 516 of FIG. 5. The executable instructions of blocks 510, 512, 514, and 516 of FIG. 5 may be executed on at least one processor such as the example processor 712 of FIG. 7. In other examples, the means for managing demographics is implemented by hardware logic, hardware implemented state machines, logic circuitry, and/or any other combination of hardware, software, and/or firmware.

In the illustrated example of FIG. 2, the score management controller 214 is implemented by processor circuitry executing instructions. In additional or alternative examples, the score management controller 214 can be implemented by one or more analog or digital circuit(s), logic circuits, programmable processor(s), programmable controller(s), GPU(s), DSP(s), ASIC(s), PLD(s) and/or FPLD(s). In the example of FIG. 2, the score management controller 214 determines respective total scores for the panelists associated with the selected user account based on the respective impression scores, the respective gender scores, and the respective age scores of the panelists.

For example, to determine the respective total scores for the panelists, the score management controller 214 sums the respective impression score, the respective gender score, and the respective age score of the panelists. The score management controller 214 determines the total score for a panelist to be the sum of the score the panelist attained in each category (e.g., impression score, gender score, and age score) out of the total possible points for the sum of those categories. Thus, if a first panelist has an impression score of four out of five (e.g., 4/5), a gender score of five out of five (e.g., 5/5), and an age score of two out of five (e.g., 2/5), the score management controller 214 determines the total score for the first panelist to be 11 (e.g., 11=4+5+2) out of 15 (15=5+5+5).

Examples disclosed herein use the same scale for impression scores, gender scores, and age score (e.g., a five-point scale, x/5, etc.). In this manner, the impression scores, gender scores, and age scores are normalized which allows for equal weighting for the categories (e.g., impression score, gender, score, age score). In additional or alternative examples, different scales can be used for each category. In this manner, if a category is considered more important, the category can be weighed more by increasing the possible score (e.g., a ten-point scale, x/10, etc.).

In the illustrated example of FIG. 2, after determining the respective total scores for the panelists associated with the selected user account, the score management controller 214 compares the respective percentages of impressions of the panelists associated with the respective total scores to a first threshold. For example, the score management controller 214 compares the respective percentages of impression to the first threshold to determine if any total score is based on a percentage of impressions that satisfies (e.g., exceeds) the first threshold. In examples disclosed herein, the first threshold is 50%.

In this manner, only the panelist with the highest percentage of impressions can be selected as the primary user of the selected user account, provided the percent satisfied the first threshold (e.g., exceeds 50%). In additional or alternative examples, a different percentage can be used for the first threshold. If multiple total scores are based on percentages of impressions that satisfy the first threshold, the score management controller 214 selects a highest one of the total scores.

In the illustrated example of FIG. 2, the score management controller 214 additionally compares the selected total score to a second threshold to determine whether the selected total score satisfies (e.g., exceeds) the second threshold. In examples disclosed herein, the second threshold is configurable and may be tuned as necessary to achieve reliable data that provides accurate modeling. In response to the score management controller 214 determining that the selected total score does not satisfy the second threshold, the score management controller 214 disregards the selected user account. In some examples, if the score management controller 214 determines that the selected total score does not satisfy the second threshold and the data matching analyzer 128 determines that the AME panel data matches similar data provided by the database proprietor 102, the score management controller 214 forwards the data associated with the impression identifier (e.g., a CPN) and the corresponding AME panel data to the network interface 206 to be stored in the user-level covariate data database 204.

In the illustrated example of FIG. 2, in response to the score management controller 214 determining that the selected total score satisfies the second threshold, the score management controller 214 forwards the demographics of the panelist with the selected total score and the selected total score to the network interface 206 to be stored in the user-level covariate data database 204. To store the demographics of the panelist with the selected total score and the selected total score in the user-level covariate data database 204, the network interface 206 associates the demographics of the panelist with the selected total score and the selected total score with the selected user account. In this manner, the select user account is associated with the demographics and other covariates of the panelist with the selected total score.

In some examples, the example score management controller 214 implements example means for managing scores. The means for managing scores is implemented by executable instructions such as that implemented by at least block 402 and 404 of FIG. 4 and/or at least blocks 518, 520, 522, 524, and 526 of FIG. 5. The executable instructions of block 402 and 404 of FIG. 4 and/or at blocks 518, 520, 522, 524, and 526 of FIG. 5 may be executed on at least one processor such as the example processor 712 of FIG. 7. In other examples, the means for managing scores is implemented by hardware logic, hardware implemented state machines, logic circuitry, and/or any other combination of hardware, software, and/or firmware.

After the impression-to-user analyzer 202 corrects falsified and/or otherwise incorrect demographic data for panelists, the model generator 140 may use the corrected demographic data to train one or more demographic correction models to generate predictions and/or inferences as to the actual demographics (e.g., actual ages) of registered users (e.g., non-panelists) of the database proprietor 102. Returning to FIG. 1. with inferences made to correct for inaccurate demographic information of database proprietor users (e.g., falsified self-declared ages) and stored in the model inferences database 146, the AME 104 may be interested in extracting audience measurement metrics based on the corrected data. However, as mentioned above, the data contained inside the privacy-protected cloud environment 106 is subject to privacy constraints. In some examples, the privacy constraints ensure that the data can only be extracted for review and/or analysis in aggregate so as to protect the privacy of any particular individual represented in the data (e.g., a panelist of the AME 104 and/or a registered user of the database proprietor 102). Accordingly, in some examples, a data aggregator 148 aggregates the audience measurement data associated with particular media campaigns before the data is provided to an aggregated campaign data database 150 in the AME output data store 138 of the AME proprietary cloud environment 126.

The data aggregator 148 may aggregate data in different ways for different types of audience measurement metrics. For instance, at the highest level, the aggregated data may provide the total impression count and total number of registered users (e.g., estimated audience size) exposed to the media 108 for a particular media campaign. As mentioned above, the total number of registered users reported by the data aggregator 148 is based on the total number of unique user accounts matched to impressions but does not include the individuals associated with impressions that were not matched to a particular registered user (e.g., non-coverage). However, the total number of unique user accounts does not account for the fact that a single individual may correspond to more than one user account (e.g., multi-account users), and does not account for situations where a person other than a registered user was exposed to the media 108 (e.g., misattribution). These errors in the aggregated data may be corrected based on the adjustment factors stored in the adjustment factors database 136. Further, in some examples, the aggregated data may include an indication of the demographic composition of the registered users represented in the aggregated data (e.g., number of males vs females, number of registered users in different age brackets, etc.).

Additionally or alternatively, in some examples, the data aggregator 148 may provide aggregated data that is associated with a particular aspect of a media campaign. For instance, the data may be aggregated based on particular sites (e.g., all media impressions served on YouTube.com). In other examples, the data may be aggregated based on placement information (e.g., aggregated based on particular primary content videos accessed by users when the media advertisement was served). In other examples, the data may be aggregated based on device type (e.g., impressions served via a desktop computer versus impressions served via a mobile device). In other examples, the data may be aggregated based on a combination of one or more of the above factors and/or based on any other relevant factor(s).

In some examples, the privacy constraints imposed on the data within the privacy-protected cloud environment 106 include a limitation that data cannot be extracted (even when aggregated) for less than a threshold number of individuals (e.g., 50 individuals). Accordingly, if the particular metric being sought includes less than the threshold number of individuals, the data aggregator 148 will not provide such data. For instance, if the threshold number of individuals is 50 but there are only 46 females in the age range of 18-25 that were exposed to particular media 108, the data aggregator 148 would not provide the aggregate data for females in the 18-25 age bracket. Such privacy constraints can leave gaps in the audience measurement metrics, particularly in locations where the number of panelists is relatively small. Accordingly, in some examples, when audience measurement is not available for a particular demographic segment of interest in a particular region (e.g., a particular country), the audience measurement metrics in one or more comparable region(s) may be used to impute the metrics for the missing data in the first region of interest. In some examples, the particular metrics imputed from comparable regions is based on a comparison of audience metrics for which data is available in both regions. For instance, while data for females in the 18-25 bracket may be unavailable, assume that data for females in the 26-35 age bracket is available. The metrics associated with the 26-35 age bracket in the region of interests may be compared with metrics for the 26-35 age bracket in other regions and the regions with the closest metrics to the region of interest may be selected for use in calculating imputation factor(s).

As shown in the illustrated example, both the adjustment factors database 136 and the aggregated campaigns data database 150 are included within the AME output data store 138 of the AME proprietary cloud environment 126. As mentioned above, in some examples, the AME proprietary cloud environment 126 is provided by the database proprietor 102 and enables data to be provided to and retrieved from the privacy-protected cloud environment. In some examples, the aggregated campaign data and the adjustment factors are subsequently transferred to a separate computing apparatus 152 of the AME 104 for analysis by an audience metrics analyzer 154. In some examples, the separate computing apparatus may be omitted with its functionality provided by the AME proprietary cloud environment 126. In other examples, the AME proprietary cloud environment 126 may be omitted with the adjustment factors and the aggregated data provided directly to the computing apparatus 152. Further, in this example, the AME panel data database 122 is within the AME first party data store 124, which is shown as being separate from the AME output data store 138. However, in other examples, the AME first party data store 124 and the AME output data store 138 may be combined.

In the illustrated example of FIG. 1, the audience metrics analyzer 154 applies the adjustment factors to the aggregated data to correct for errors in the data including misattribution, non-coverage, and multi-count users. The output of the audience metrics analyzer 154 corresponds to the final calibrated data of the AME 104 and is stored in a final calibrated data database 156. In this example, the computing apparatus 152 also includes a report generator 158 to generate reports based on the final calibrated data.

While an example manner of implementing the privacy-protected cloud environment 106 of FIG. 1 is illustrated in FIG. 1, one or more of the elements, processes and/or devices illustrated in FIG. 1 may be combined, divided, re-arranged, omitted, eliminated and/or implemented in any other way. Further, the example campaign impressions database 116, example matchable impressions database 118, the example enriched campaign impressions database 120, the example data matching analyzer 128, the example AME intermediary merged data database 130, the example AME privacy-protected data store 132, the example adjustment factor analyzer 134, the example impression-to-user analyzer 202, the example user-level covariate database 204, the example network interface 206, the example user account controller 208, the example impression controller 210, the example demographic controller 212, the example score management controller 214, the example model generator 140, the example demographic correction models database 142, the example model analyzer 144, the example model inferences database 146, the example data aggregator 148, and/or, more generally, the example privacy-protected cloud environment 106 of FIG. 1 and/or FIG. 2 may be implemented by hardware, software, firmware and/or any combination of hardware, software and/or firmware. Thus, for example, any of the example campaign impressions database 116, example matchable impressions database 118, the example enriched campaign impressions database 120, the example data matching analyzer 128, the example AME intermediary merged data database 130, the example AME privacy-protected data store 132, the example adjustment factor analyzer 134, the example impression-to-user analyzer 202, the example user-level covariate database 204, the example network interface 206, the example user account controller 208, the example impression controller 210, the example demographic controller 212, the example score management controller 214, the example model generator 140, the example demographic correction models database 142, the example model analyzer 144, the example model inferences database 146, the example data aggregator 148, and/or, more generally, the example privacy-protected cloud environment 106 of FIG. 1 and/or FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example campaign impressions database 116, example matchable impressions database 118, the example enriched campaign impressions database 120, the example data matching analyzer 128, the example AME intermediary merged data database 130, the example AME privacy-protected data store 132, the example adjustment factor analyzer 134, the example impression-to-user analyzer 202, the example user-level covariate database 204, the example network interface 206, the example user account controller 208, the example impression controller 210, the example demographic controller 212, the example score management controller 214, the example model generator 140, the example demographic correction models database 142, the example model analyzer 144, the example model inferences database 146, the example data aggregator 148 is/are hereby expressly defined to include a non-transitory computer readable storage device or storage disk such as a memory, a digital versatile disk (DVD), a compact disk (CD), a Blu-ray disk, etc. including the software and/or firmware. Further still, the example privacy-protected cloud environment 106 of FIG. 1 may include one or more elements, processes and/or devices in addition to, or instead of, those illustrated in FIG. 1 and/or FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowchart representative of example hardware logic, machine readable instructions, hardware implemented state machines, and/or any combination thereof for implementing aspects of the privacy-protected cloud environment 106 of FIG. 1 are shown in FIGS. 3, 4, and/or 5. The machine readable instructions may be one or more executable programs or portion(s) of an executable program for execution by a computer processor and/or processor circuitry, such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 3, 4, and/or 5, many other methods of implementing the example privacy-protected cloud environment 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example processes of FIGS. 3, 4, and/or 5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” item, as used herein, refers to one or more of that item. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 3 is a flowchart representative of machine readable instructions 300 which may be executed to implement the privacy-protected cloud environment 106 of FIG. 2. The privacy-protected cloud environment 106 executes the machine readable instructions 300 to develop training data with which to train one or more machine learning models. For example, by using the AME panel data, the privacy-protected cloud environment 106 can identify training data relating demographic data of panelist primary users to demographic data of panelist registered users. In this manner, the privacy-protected cloud environment 106 may use the training data to train one or more machine learning models to correct demographic data for non-panelist registered users.

In the illustrated example of FIG. 3, the machine readable instructions 300 begin at block 302 where the impression-to-user analyzer 202 determines primary users from among multiple potential users of panelist user accounts of the database proprietor 102. Detailed machine readable instructions to determine primary users from among multiple potential users of panelist user accounts of the database proprietor 102 are illustrated and described in connection with FIG. 4. Additional or alternative detailed machine readable instructions to determine primary users from among multiple potential users of panelist user accounts of the database proprietor 102 are illustrated and described in connection with FIG. 5.

In the illustrated example of FIG. 3, at block 304, the model generator 140 generates a demographic correction model based on the identified primary users. For example, the model generator 140 executes a training algorithm (e.g., stochastic gradient descent) to train a machine learning model to correct demographics (e.g., self-reported age) of registered users of the database proprietor 102 using the demographics of the identified primary users as training data. In this manner, the model analyzer 144 may execute one or more trained demographic correction models to correct demographics of non-panelist registered users of the database proprietor 102.

FIG. 4 is a flowchart representative of machine readable instructions 302 which may be executed to implement the example impression-to-user analyzer 202 of FIG. 2 to determine primary users from among multiple potential users of panelist user accounts of the database proprietor 102. For example, multiple panelists of a panelist household may utilize the same user account to view media including advertisements. In some examples, processor circuitry executes the machine readable instructions 302 to implement the impression-to-user analyzer 202 to determine primary users from among multiple potential users of panelists user accounts of the database proprietor 102.

In the illustrated example of FIG. 4, the machine readable instructions 302 begin at block 402 where the score management controller 214 determines a first total score for a first panelist associated with a panelist user account. At block 404, the score management controller 214 determines a second total score for a second panelist associated with the panelist user account. In the example of FIG. 4, the respective total scores are based respective impression scores, respective gender scores, and respective age scores of the two panelists.

In the illustrated example of FIG. 4, at block 406, in response to the score management controller 214 determining that the first total score satisfies (e.g., exceeds) a threshold, the network interface 206 stores demographics of the first panelist for the panelist user account (e.g., the network interface 206 is configured to store demographics of the first panelist for the panelist user account). In the example of FIG. 4, the threshold corresponds to a configurable value that may be tuned as necessary to achieve reliable data that provides accurate modeling. In this manner, the impression-to-user analyzer 202 determines the primary user of the panelist user account of the database proprietor 102 and adjusts demographic information of the panelist user account to reflect the primary user of the panelist user account.

FIG. 5 is another flowchart representative of machine readable instructions 302 which may be executed to implement the example impression-to-user analyzer 202 of FIG. 2 to determine primary users of panelist user accounts of the database proprietor 102. The machine readable instructions 302 begin at block 502 where the network interface 206 obtains the AME intermediary merged data from the AME intermediary merged data database 130.

In the illustrated example of FIG. 5, at block 504, the user account controller 208 selects a user account. At block 506, the impression controller 210 determines respective percentages of impressions for the selected panelist user account that are attributed to the panelists associated with the panelist user account. For example, multiple panelists may be associated with a single user account (e.g., multiple panelists in the same panelist household) such that the user account may be a shared user account where the registered user is not the same as the primary user. In some examples, the impression controller 210 determines the number of impressions logged for each user account registered with the database proprietor 102.

In the illustrated example of FIG. 5, to determine the number of impressions logged for each panelist associated with the user account, the impression controller 210 determines whether a panelist was served a prompt to self-identify and, if so, the panelists response to that prompt. For example, the prompt may also ask the panelist to identify which other individuals are present at the time of the prompt. Based on the total number of impressions logged for the selected user account and the number of impressions logged for each panelist of the user account, the impression controller 210 determines the respective percentages of impressions for the user account that are attributed to the panelists.

In the illustrated example of FIG. 5, at block 508, the impression controller 210 defines respective impression scores for the panelists associated with the user account. In some examples, the higher the percentage determined at block 508, the higher the impression score. For example, the impression controller 210 determines the impression score for each panelist based on the percentage of impression attributed to each panelist. In some examples, if between 60% and 80% of the impressions associated with the selected user account are attributed to a first panelist, the impression controller 210 assigns an impression score of four out of five (e.g., 4/5) for the first panelist.

In the illustrated example of FIG. 5, at block 510, the demographic controller 212 compares a self-declared gender of the selected user account (indicated in the database proprietor impressions data) to the respective genders of the panelists as indicated from the AME panel data. At block 512, the demographic controller 212 defines respective gender scores for the panelists associated with the user account. In some examples, the gender score is assigned based on whether the self-declared gender of the selected user account matches the AME panel data, does not match the panel, or is undetermined, unknown (e.g., when the self-declared gender is not provided), or non-binary. In some examples, a higher gender score is assigned when the self-declared gender matches the AME panel data.

In the illustrated example of FIG. 5, at block 514, the demographic controller 212 compares the self-declared age of the selected user account (indicated in the database proprietor impressions data) to the respective ages of the panelists as indicated from the AME panel data. At block 516, the demographic controller 212 defines respective age scores for the panelists associated with the user account. In some examples, as the difference between the self-declared age and the age indicated by the AME panel data decreases, the age score increases.

In the illustrated example of FIG. 5, at block 518, the score management controller 214 determines respective total scores for the panelists based on the respective impression scores, the respective gender scores, and the respective age scores of the panelists. At block 520, the score management controller 214 determines whether any of the respective total scores is based on a percentage of impression that satisfies a first threshold. For example, the score management controller 214 determines whether any of the respective total scores is based on a percentage of impressions that exceeds a first threshold of 50%.

In the illustrated example of FIG. 5, in response to the score management controller 214 determining that none of the respective total scores are based on a percentage of impressions that satisfies the first threshold (block 520: NO), the machine readable instructions 302 proceed to block 526. In response to the score management controller 214 determining that at least one of the respective total scores is based on a percentage of impressions that satisfies the first threshold (block 520: YES), the machine readable instructions 302 proceed to block 522. At block 522, the score management controller 214 selects a highest one of the total scores that satisfy the first threshold. In examples disclosed herein, the first threshold is 50%, but in some examples other percentages may be used (e.g., 30%, 40%, etc.). Thus, in such cases, the score management controller 214 selects the highest one of the total scores that satisfy the first threshold.

In the illustrated example of FIG. 5, at block 524, the score management controller 214 determines whether the selected total score satisfies a second threshold. In examples disclosed herein, the selected total score satisfying the second threshold indicates that the selected total score is high enough to achieve reliable data that provides accurate modeling. In response to the score management controller 214 determining that the selected total score does not satisfy the second threshold (block 524: NO), the machine readable instructions 302 proceed to block 526. In response to the score management controller 214 determining that the selected total score satisfies the second threshold (block 524: YES), the machine readable instructions 302 proceed to block 528.

In the illustrated example of FIG. 5, at block 526, the score management controller 214 disregards the selected user account. At block 528, the network interface 206 stores demographics of the panelist with the selected total score for the user account (e.g., in the user-level covariate data database 204). At block 530, the user account controller 208 determines whether there is another panelist user account to be analyzed in the AME intermediary merged data. In response to the user account controller 208 determining that there is another panelist user account to be analyzed in the AME intermediary merged data (block 530: YES), the machine readable instructions 302 proceed to block 532. At block 532, the user account controller 208 selects a next user account. Thereafter, the machine readable instructions 302 return to block 506. In response to the user account controller 208 determining that there is not another panelist user account to be analyzed in the AME intermediary merged data (block 530: NO), the machine readable instructions 302 return to the machine readable instructions 300 at block 304.

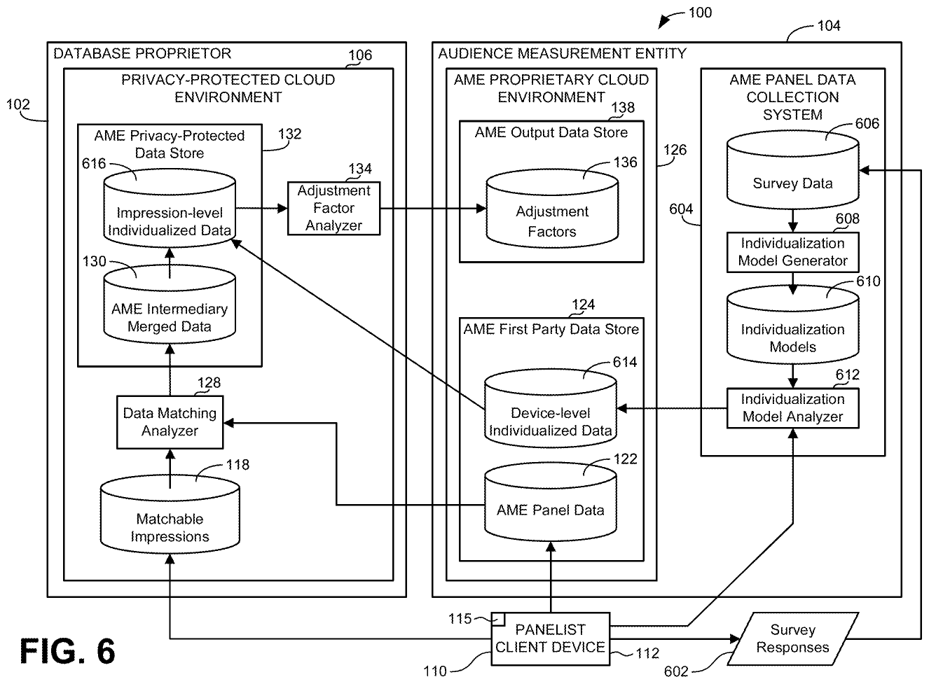

FIG. 6 illustrates the example system 100 of FIG. 1. However, some aspects of FIG. 1 are omitted from FIG. 6 for the sake of clarity to discuss the process by which the AME is able to correct for misattribution within panel data in situations where the actual user of the panelist client devices 112 are not known (e.g., the user was not prompted to self-identify). Users are typically not prompted to self-identify when they are using mobile devices. Accordingly, the illustrated example is described with respect to mobile devices. However, teachings disclosed herein to correct misattribution of panel data may be applied to any type of panelist client device 112. As represented in the illustrated example of FIG. 6, the AME 104 performs one or more surveys of a subset of panelists that use mobile devices to elicit survey responses 602. In some examples, the surveys may be electronically administered (e.g., via the panelist client devices 112 and/or other computing device) to ask the panelists about their behavior and usage of the panelist client devices 112 through which the AME 104 collects the AME panel data. In some examples, the survey is designed to collect survey responses providing information about whether other people besides the panelist use the panelist client device; if so, how often each person uses the device; when (e.g., day part, time of day, time of week, etc.) each person uses the device; the types and/or categories of website and/or applications used and/or visited by each user of the device; the type, genre, and/or characteristics of videos and/or other content accessed by each user of the device, and so forth. As shown in the illustrated example, the survey response 602 are collected by an AME panel data collection system 604 and stored in a survey data database 606. The survey data may include additional information the AME 104 already knows about the panelist such as who the primary user of the device is, the type of the device (e.g., tablet versus smartphone), the demographic composition (e.g., ages, genders, etc.) of all individuals in the panelist household, and/or any other relevant information. In this example, the AME panel data collection system 604 is a separate system from the computing apparatus 152 shown in FIG. 1 and omitted in FIG. 6 for the sake of clarity. However, in other examples, the AME panel data collection system 604 may correspond to and/or include the computing apparatus 152.

In some examples, the survey data serves as truth data that is used by an individualization model generator 608 to train and validate a model (referred to herein as an individualization model) that can predict the true user of a mobile device (when such information is unavailable) based on information that the AME 104 does know for certain and/or has access to through the collection of panel data via the meter 115. Once the individualization model has been trained and validated based on the AME panel data, the model is stored in an individualization models database 610. In some examples, an individualization model analyzer 612 may implement the individualization model to generate predictions and/or inferences as to the actual users associated with media impressions captured by the audience measurement meters 115 of associated mobile panelist client devices 112. That is, in some examples, as shown in FIG. 1, the individualization model analyzer 612 uses the individualization model to analyze the usage behavior (at the time of particular media impressions) reported from a meter 115 on a particular panelist client device 112. This analysis is performed in conjunction with known information about the demographic composition of the household of the panelist(s) associated with the device to predict the actual user of the panelist client device 112 at the time of the media impression rather than automatically associating the impression with the primary user of the panelist client device 112.

In the illustrated example of FIG. 6, the output of the individualization model analyzer 612 is passed to a device-level individualized data database 614 in the AME first party data store 124 to enable the data to be used to generate an impression-level individualized data database 616 within the AME privacy-protected data store 132 of the privacy-protected cloud environment 106. In some examples, the output of the individualization model analyzer 612 may be stored locally by the AME panel data collection system 604 before the data is provided to the device-level individualized data database 614.

As represented in FIG. 6, the information in the impression-level individualized data database 616 results from the combination of the device-level individuals data (in the device-level individualized data database 614) and the AME intermediary merged data (in the AME intermediary merged data database 130). That is, the actual user for a particular impression (determined from the device-level individualized data) is matched with the AME panel data that has been enriched by the covariates provided by the database proprietor 102.

In some examples, only the predictions for the feature combinations analyzed by the individualization model analyzer 612 (e.g., daypart, genre, category, device type, etc.) that match the feature combinations (e.g., covariates) provided by the database proprietor 102 are retained in the impression-level individualized data database 616. For example, assume that daypart is the only feature used in the individualization model. Further assume that for a particular panelist client device 112, the individualization model predicts that person A is the actual user of the device when the daypart=morning, person B is the actual user of the device when the daypart=midday, and person C is the actual user of the device when the daypart=evening. All of these predictions are stored within the device-level individuals data database 614 in connection with the particular panelist client device 112. Now assume that the database proprietor impressions data indicates that a particular impression that was logged for the particular panelist client device 112 occurred when daypart=midday. In such a situation, person B would be assigned as the actual user for that particular impression in the impression-level individualized data database 616 and the predictions for the morning and evening dayparts would not be used (at least for that particular impression). Once the AME intermediary merged data has been corrected in this manner, the process to calculate adjustment factors and perform other analyses as disclosed herein proceeds in a similar manner as outlined above.

FIG. 7 is a block diagram of an example processor platform 700 structured to execute the instructions of FIGS. 3, 4, and/or 5 to implement the privacy-protected cloud environment 106 and/or the impression-to-user analyzer 202 of FIG. 2. The processor platform 700 can be, for example, a server, a personal computer, a workstation, a self-learning machine (e.g., a neural network), or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor 712 may be a semiconductor based (e.g., silicon based) device. In this example, the processor 712 implements the example network interface 206, the example user account controller 208, the example impression controller 210, the example demographic controller 212, the example score management controller 214, and the model generator 140.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 3, 4, and/or 5 may be stored in the mass storage device 728, in the volatile memory 714, in the non-volatile memory 716, and/or on a removable non-transitory computer readable storage medium such as a CD or DVD.

From the foregoing, it will be appreciated that example methods, apparatus, and articles of manufacture have been disclosed that enable the generation of accurate and reliable audience measurement metrics for Internet-based media without the use of third-party cookies and/or tags that have been the standard approach for monitoring Internet media for many years. This is accomplished by merging AME panel data with database proprietor impressions data within a privacy-protected cloud based environment. The nature of the cloud environment and the privacy constraints imposed thereon as well as the nature in which the database proprietor collects the database proprietor impression data present technological challenges contributing to limitations in the reliability and/or completeness of the data.

However, examples disclosed herein overcome these difficulties by generating adjustment factors and/or machine learning models based on the AME panel data. The disclosed examples correct for misreported demographic data associated with a user account by assessing differences between demographic data provided by databases proprietors and similar demographic data provided by an AME. For example, the disclosed methods, apparatus, and articles of manufacture correct computer errors in audience metrics generated as a result of registered users reporting incorrect demographics. Registered users can purposefully and/or inadvertently report incorrect demographic information due to the nature and medium of reporting being electronic (e.g., via a computer and/or the Internet). The disclosed methods, apparatus, and articles of manufacture correct for this error by establishing a reliable training dataset relating panelist primary users to panelist registered users. Having established a reliable training dataset, examples disclosed herein train one or more machine learning models to correct demographic information for non-panelist registered users.

Example methods, apparatus, systems, and articles of manufacture to adjust demographic information of user accounts to reflect primary users of the user accounts are disclosed herein. Further examples and combinations thereof include the following:

Example 1 includes an apparatus comprising memory, and processor circuitry to execute instructions that cause the processor circuitry to at least determine a first total score for a first panelist associated with a panelist user account based on at least one of a first impression score, a first age score, or a first gender score, determine a second total score for a second panelist associated with the panelist user account based on at least one of a second impression score, a second age score, or a second gender score, and in response to determining that the first total score satisfies a threshold, store demographics of the first panelist for the panelist user account.

Example 2 includes the apparatus of example 1, wherein the processor circuitry is to determine a first percentage of impressions for the panelist user account that are attributed to the first panelist, determine a second percentage of impressions for the panelist user account that are attributed to the second panelist, define the first impression score for the first panelist based on the first percentage of impressions, and define the second impression score for the second panelist based on the second percentage of impressions.

Example 3 includes the apparatus of example 1, wherein the processor circuitry is to compare a self-declared gender of the panelist user account to a first gender of the first panelist and a second gender of the second panelist, define the first gender score for the first panelist based on the comparison, and define the second gender score for the second panelist based on the comparison.

Example 4 includes the apparatus of example 1, wherein the processor circuitry is to compare a self-declared age of the panelist user account to a first age of the first panelist and a second age of the second panelist, define the first age score for the first panelist based on the comparison, and define the second age score for the second panelist based on the comparison.

Example 5 includes the apparatus of example 1, wherein the processor circuitry is to determine whether the first total score satisfies the threshold.

Example 6 includes the apparatus of example 1, wherein the processor circuitry is to, in response to determining that the first total score does not satisfy the threshold, disregard the panelist user account.

Example 7 includes the apparatus of example 1, wherein the threshold is a first threshold and the processor circuitry is to determine whether a first percentage of impressions for the panelist user account that are attributed to the first panelist and on which the first total score is based satisfies a second threshold, and in response to the first total score satisfying the first threshold and the first percentage of impressions satisfying the second threshold, store the demographics of the first panelist for the panelist user account.

Example 8 includes the apparatus of example 1, wherein the processor circuitry is to generate one or more demographic correction models based on the demographics of the first panelist.

Example 9 includes an apparatus comprising a score management controller to determine a first total score for a first panelist associated with a panelist user account based on at least one of a first impression score, a first age score, or a first gender score, and determine a second total score for a second panelist associated with the panelist user account based on at least one of a second impression score, a second age score, or a second gender score, and a network interface to, in response to determining that the first total score satisfies a threshold, store demographics of the first panelist for the panelist user account.

Example 10 includes the apparatus of example 9, further including an impression controller to determine a first percentage of impressions for the panelist user account that are attributed to the first panelist, determine a second percentage of impressions for the panelist user account that are attributed to the second panelist, define the first impression score for the first panelist based on the first percentage of impressions, and define the second impression score for the second panelist based on the second percentage of impressions.

Example 11 includes the apparatus of example 9, further including a demographic controller to compare a self-declared gender of the panelist user account to a first gender of the first panelist and a second gender of the second panelist, define the first gender score for the first panelist based on the comparison, and define the second gender score for the second panelist based on the comparison.

Example 12 includes the apparatus of example 9, further including a demographic controller to compare a self-declared age of the panelist user account to a first age of the first panelist and a second age of the second panelist, define the first age score for the first panelist based on the comparison, and define the second age score for the second panelist based on the comparison.

Example 13 includes the apparatus of example 9, wherein the score management controller is to determine whether the first total score satisfies the threshold.

Example 14 includes the apparatus of example 9, wherein the score management controller is to, in response to determining that the first total score does not satisfy the threshold, disregard the panelist user account.

Example 15 includes the apparatus of example 9, wherein the threshold is a first threshold, the score management controller is to determine whether a first percentage of impressions for the panelist user account that are attributed to the first panelist and on which the first total score is based satisfies a second threshold, and the network interface is to, in response to the first total score satisfying the first threshold and the first percentage of impressions satisfying the second threshold, store the demographics of the first panelist for the panelist user account.

Example 16 includes the apparatus of example 9, further including a model generator to generate one or more demographic correction models based on the demographics of the first panelist.

Example 17 includes a non-transitory computer readable storage medium comprising instruction which, when executed, cause at least one processor to at least determine a first total score for a first panelist associated with a panelist user account based on at least one of a first impression score, a first age score, or a first gender score, determine a second total score for a second panelist associated with the panelist user account based on at least one of a second impression score, a second age score, or a second gender score, and in response to determining that the first total score satisfies a threshold, store demographics of the first panelist for the panelist user account.

Example 18 includes the non-transitory computer readable storage medium of example 17, wherein the instructions, when executed, cause the at least one processor to determine a first percentage of impressions for the panelist user account that are attributed to the first panelist, determine a second percentage of impressions for the panelist user account that are attributed to the second panelist, define the first impression score for the first panelist based on the first percentage of impressions, and define the second impression score for the second panelist based on the second percentage of impressions.

Example 19 includes the non-transitory computer readable storage medium of example 17, wherein the instructions, when executed, cause the at least one processor to compare a self-declared gender of the panelist user account to a first gender of the first panelist and a second gender of the second panelist, define the first gender score for the first panelist based on the comparison, and define the second gender score for the second panelist based on the comparison.

Example 20 includes the non-transitory computer readable storage medium of example 17, wherein the instructions, when executed, cause the at least one processor to compare a self-declared age of the panelist user account to a first age of the first panelist and a second age of the second panelist, define the first age score for the first panelist based on the comparison, and define the second age score for the second panelist based on the comparison.

Example 21 includes the non-transitory computer readable storage medium of example 17, wherein the instructions, when executed, cause the at least one processor to determine whether the first total score satisfies the threshold.

Example 22 includes the non-transitory computer readable storage medium of example 17, wherein the instructions, when executed, cause the at least one processor to, in response to determining that the first total score does not satisfy the threshold, disregard the panelist user account.

Example 23 includes the non-transitory computer readable storage medium of example 17, wherein the threshold is a first threshold and the instructions, when executed, cause the at least one processor to determine whether a first percentage of impressions for the panelist user account that are attributed to the first panelist and on which the first total score is based satisfies a second threshold, and in response to the first total score satisfying the first threshold and the first percentage of impressions satisfying the second threshold, store the demographics of the first panelist for the panelist user account.

Example 24 includes the non-transitory computer readable storage medium of example 17, wherein the instructions, when executed, cause the at least one processor to generate one or more demographic correction models based on the demographics of the first panelist.

Example 25 includes a method comprising determining a first total score for a first panelist associated with a panelist user account based on at least one of a first impression score, a first age score, or a first gender score, determining a second total score for a second panelist associated with the panelist user account based on at least one of a second impression score, a second age score, or a second gender score, and in response to determining that the first total score satisfies a threshold, storing demographics of the first panelist for the panelist user account.

Example 26 includes the method of example 25, further including determining a first percentage of impressions for the panelist user account that are attributed to the first panelist, determining a second percentage of impressions for the panelist user account that are attributed to the second panelist, defining the first impression score for the first panelist based on the first percentage of impressions, and defining the second impression score for the second panelist based on the second percentage of impressions.

Example 27 includes the method of example 25, further including comparing a self-declared gender of the panelist user account to a first gender of the first panelist and a second gender of the second panelist, defining the first gender score for the first panelist based on the comparison, and defining the second gender score for the second panelist based on the comparison.

Example 28 includes the method of example 25, further including comparing a self-declared age of the panelist user account to a first age of the first panelist and a second age of the second panelist, defining the first age score for the first panelist based on the comparison, and defining the second age score for the second panelist based on the comparison.

Example 29 includes the method of example 25, further including determining whether the first total score satisfies the threshold.

Example 30 includes the method of example 25, further including, in response to determining that the first total score does not satisfy the threshold, disregarding the panelist user account.

Example 31 includes the method of example 25, wherein the threshold is a first threshold and the method further includes determining whether a first percentage of impressions for the panelist user account that are attributed to the first panelist and on which the first total score is based satisfies a second threshold, and in response to the first total score satisfying the first threshold and the first percentage of impressions satisfying the second threshold, storing the demographics of the first panelist for the panelist user account.

Example 32 includes the method of example 25, further including generating one or more demographic correction models based on the demographics of the first panelist.

Example 33 includes an apparatus comprising means for managing scores to determine a first total score for a first panelist associated with a panelist user account based on at least one of a first impression score, a first age score, or a first gender score, and determine a second total score for a second panelist associated with the panelist user account based on at least one of a second impression score, a second age score, or a second gender score, and means for interfacing to, in response to determining that the first total score satisfies a threshold, store demographics of the first panelist for the panelist user account.

Example 34 includes the apparatus of example 33, further including means for managing impressions to determine a first percentage of impressions for the panelist user account that are attributed to the first panelist, determine a second percentage of impressions for the panelist user account that are attributed to the second panelist, define the first impression score for the first panelist based on the first percentage of impressions, and define the second impression score for the second panelist based on the second percentage of impressions.

Example 35 includes the apparatus of example 33, further including means for managing demographics to compare a self-declared gender of the panelist user account to a first gender of the first panelist and a second gender of the second panelist, define the first gender score for the first panelist based on the comparison, and define the second gender score for the second panelist based on the comparison.

Example 36 includes the apparatus of example 33, further including means for managing demographics to compare a self-declared age of the panelist user account to a first age of the first panelist and a second age of the second panelist, define the first age score for the first panelist based on the comparison, and define the second age score for the second panelist based on the comparison.

Example 37 includes the apparatus of example 33, wherein the means for managing scores are to determine whether the first total score satisfies the threshold.

Example 38 includes the apparatus of example 33, wherein the means for managing scores are to, in response to determining that the first total score does not satisfy the threshold, disregard the panelist user account.

Example 39 includes the apparatus of example 33, wherein the threshold is a first threshold, the means for managing scores are to determine whether a first percentage of impressions for the panelist user account that are attributed to the first panelist and on which the first total score is based satisfies a second threshold, and the means for interfacing are to, in response to the first total score satisfying the first threshold and the first percentage of impressions satisfying the second threshold, store the demographics of the first panelist for the panelist user account.

Example 40 includes the apparatus of example 33, further including means for generating models to generate one or more demographic correction models based on the demographics of the first panelist.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A computing system comprising:
a database proprietor computing system of a first cloud-based environment, the database proprietor computing system comprising:
a network interface;
a processor; and
a non-transitory computer-readable storage medium, having stored thereon program instructions that, upon execution by the processor, cause performance of operations comprising:
obtaining database proprietor impression data associated with multiple user accounts established by registered users of a database proprietor, the database proprietor impression data logged based on network communications from client devices of the registered users, the database proprietor impression data having at least one computer-generated misattribution error in which an impression of media accessed by a given one of the client devices via a given one of the user accounts is misattributed to demographic data of a given one of the registered users that established the given one of the user accounts;
obtaining, via the network interface, panel data from an audience measurement entity computing system of a second cloud-based environment and via an application programming interface that connects the audience measurement computing system to the database proprietor computing system, the panel data comprising media impression data and corresponding demographic data for audience members of panelist households of an audience measurement entity;
merging the audience measurement panel data with the database proprietor impression data by matching at least a portion of the user accounts with at least a portion of the audience members of the panelist households based on impression identifiers collected in connection with the media impression data and the database proprietor impression data,
based on the matching, identifying panelist user accounts, each panelist user account being a respective one of the user accounts matched to multiple ones of the audience members, wherein the multiple ones of the audience members are potential users of the panelist user account;
determining, for each of one or more of the panelist user accounts, a primary user from among the potential users by:
determining a first score for a first potential user based on a first comparison between (i) first demographic data specified by the panel data for the first potential user and (ii) second demographic data specified by the database proprietor impression data for a registered user that established the panelist user account, the second demographic data being self-declared demographic data from the registered user,
determining a second score for a second potential user based on a second comparison between (i) third demographic data specified by the panel data for the second potential user and (ii) the second demographic data,
based on a determination that the first score is greater than the second score:
determining that the first potential user is the primary user for the panelist user account, and
modifying the second demographic data based on the first demographic data;
generating a demographic correction model using the determined primary users and corresponding modified second demographic data of each of the one or more of the panelist user accounts as training data; and
applying the demographic correction model to correct the at least one computer-generated misattribution error in the database proprietor impression data,
wherein the audience measurement computing system is configured to:
collect the panel data by communicating with audience measurement meters of the panelist households over a network, and
transmit the panel data to the database proprietor computing system via the application programming interface.

2. The computing system of claim 1, further comprising the audience measurement computing system.

3. The computing system of claim 1, wherein applying the demographic correction model to correct the at least one computer-generated misattribution error comprises applying the demographic correction model to correct at least one computer-generated misattribution error in which inaccurate demographics were assigned to impressions logged in connection with a subset of the registered users who are not panelists of the audience measurement entity.

4. The computing system of claim 1, wherein modifying the second demographic data based on the first demographic comprises assigning at least a portion of the first demographic data to the panelist user account.

5. The computing system of claim 1, wherein:
the first score comprises a first gender score,
the first demographics data comprises a first gender of the first potential user,
the second demographics data comprises a second gender of the registered user,
the third demographics data comprises a third gender of the second potential user,
the first comparison comprises a comparison between the first gender and the second gender, and
the second comparison comprises a comparison between the third gender and the second gender.

6. The computing system of claim 1, wherein:
the first score comprises a first age score,
the first demographics data comprises a first age of the first potential user,
the second demographics data comprises a second age of the registered user,
the third demographics data comprises a third age of the second potential user,
the first comparison comprises a comparison between the first age and the second age, and
the second comparison comprises a comparison between the third age and the second age.

7. The computing system of claim 1, wherein:
the audience measurement computing system is further configured to:
transmit impression responses to the client devices to cause the client devices to transmit the network communications to the database proprietor computing system, and
the operations further comprise:
in response to receiving the network communications, accessing cookies set on the client devices by the database proprietor computing system;
identifying the client devices based on the accessed cookies; and
logging the database proprietor impression data based on the identification of the client devices.

8. The computing system of claim 1, wherein the audience measurement computing system is further configured to:
based on the correction of the at least one computer-generated misattribution error in the database proprietor impression data, generate an audience metrics report based on the database proprietor impression data and the panel data.

9. A non-transitory computer-readable storage medium, having stored thereon program instructions that, upon execution by a processor of a database proprietor computing system of a first cloud-based environment, cause performance of operations comprising:
obtaining database proprietor impression data associated with multiple user accounts established by registered users of a database proprietor, the database proprietor impression data logged based on network communications from client devices of the registered users, the database proprietor impression data having at least one computer-generated misattribution error in which an impression of media accessed by a given one of the client devices via a given one of the user accounts is misattributed to demographic data of a given one of the registered users that established the given one of the user accounts;
obtaining, via a network interface, panel data from an audience measurement entity computing system of a second cloud-based environment and via an application programming interface that connects the audience measurement computing system to the database proprietor computing system, the panel data comprising media impression data and corresponding demographic data for audience members of panelist households of an audience measurement entity, wherein the audience measurement computing system is configured to collect the panel data by communicating with audience measurement meters of the panelist households over a network, and transmit the panel data to the database proprietor computing system via the application programming interface;
merging the audience measurement panel data with the database proprietor impression data by matching at least a portion of the user accounts with at least a portion of the audience members of the panelist households based on impression identifiers collected in connection with the media impression data and the database proprietor impression data,
based on the matching, identifying panelist user accounts, each panelist user account being a respective one of the user accounts matched to multiple ones of the audience members, wherein the multiple ones of the audience members are potential users of the panelist user account;
determining, for each of one or more of the panelist user accounts, a primary user from among the potential users by:
determining a first score for a first potential user based on a first comparison between (i) first demographic data specified by the panel data for the first potential user and (ii) second demographic data specified by the database proprietor impression data for a registered user that established the panelist user account, the second demographic data being self-declared demographic data from the registered user,
determining a second score for a second potential user based on a second comparison between (i) third demographic data specified by the panel data for the second potential user and (ii) the second demographic data,
based on a determination that the first score is greater than the second score:
determining that the first potential user is the primary user for the panelist user account, and
modifying the second demographic data based on the first demographic data;
generating a demographic correction model using the determined primary users and corresponding modified second demographic data of each of the one or more of the panelist user accounts as training data; and
applying the demographic correction model to correct the at least one computer-generated misattribution error in the database proprietor impression data.

10. The non-transitory computer-readable storage medium of claim 9, wherein applying the demographic correction model to correct the at least one computer-generated misattribution error comprises applying the demographic correction model to correct at least one computer-generated misattribution error in which inaccurate demographics were assigned to impressions logged in connection with a subset of the registered users who are not panelists of the audience measurement entity.

11. The non-transitory computer-readable storage medium of claim 9, wherein modifying the second demographic data based on the first demographic comprises assigning at least a portion of the first demographic data to the panelist user account.

12. The non-transitory computer-readable storage medium of claim 9, wherein:
the first score comprises a first gender score,
the first demographics data comprises a first gender of the first potential user,
the second demographics data comprises a second gender of the registered user,
the third demographics data comprises a third gender of the second potential user,
the first comparison comprises a comparison between the first gender and the second gender, and
the second comparison comprises a comparison between the third gender and the second gender.

13. The non-transitory computer-readable storage medium of claim 9, wherein:
the first score comprises a first age score,
the first demographics data comprises a first age of the first potential user,
the second demographics data comprises a second age of the registered user,
the third demographics data comprises a third age of the second potential user,
the first comparison comprises a comparison between the first age and the second age, and
the second comparison comprises a comparison between the third age and the second age.

14. The non-transitory computer-readable storage medium of claim 9, wherein:
the audience measurement computing system is further configured to:
transmit impression responses to the client devices to cause the client devices to transmit the network communications to the database proprietor computing system, and
the operations further comprise:
in response to receiving the network communications, accessing cookies set on the client devices by the database proprietor computing system;
identifying the client devices based on the accessed cookies; and
logging the database proprietor impression data based on the identification of the client devices.

15. The non-transitory computer-readable storage medium of claim 9, wherein the audience measurement computing system is further configured to:
based on the correction of the at least one computer-generated misattribution error in the database proprietor impression data, generate an audience metrics report based on the database proprietor impression data and the panel data.

16. A method performed by a database proprietor computing system of a first cloud-based environment, the method comprising:
obtaining database proprietor impression data associated with multiple user accounts established by registered users of a database proprietor, the database proprietor impression data logged based on network communications from client devices of the registered users, the database proprietor impression data having at least one computer-generated misattribution error in which an impression of media accessed by a given one of the client devices via a given one of the user accounts is misattributed to demographic data of a given one of the registered users that established the given one of the user accounts;
obtaining, via a network interface, panel data from an audience measurement entity computing system of a second cloud-based environment and via an application programming interface that connects the audience measurement computing system to the database proprietor computing system, the panel data comprising media impression data and corresponding demographic data for audience members of panelist households of an audience measurement entity, wherein the audience measurement computing system is configured to collect the panel data by communicating with audience measurement meters of the panelist households over a network, and transmit the panel data to the database proprietor computing system via the application programming interface;
merging the audience measurement panel data with the database proprietor impression data by matching at least a portion of the user accounts with at least a portion of the audience members of the panelist households based on impression identifiers collected in connection with the media impression data and the database proprietor impression data,
based on the matching, identifying panelist user accounts, each panelist user account being a respective one of the user accounts matched to multiple ones of the audience members, wherein the multiple ones of the audience members are potential users of the panelist user account;
determining, for each of one or more of the panelist user accounts, a primary user from among the potential users by:
determining a first score for a first potential user based on a first comparison between (i) first demographic data specified by the panel data for the first potential user and (ii) second demographic data specified by the database proprietor impression data for a registered user that established the panelist user account, the second demographic data being self-declared demographic data from the registered user,
determining a second score for a second potential user based on a second comparison between (i) third demographic data specified by the panel data for the second potential user and (ii) the second demographic data,
based on a determination that the first score is greater than the second score:
determining that the first potential user is the primary user for the panelist user account, and
modifying the second demographic data based on the first demographic data;
generating a demographic correction model using the determined primary users and corresponding modified second demographic data of each of the one or more of the panelist user accounts as training data; and
applying the demographic correction model to correct the at least one computer-generated misattribution error in the database proprietor impression data.

17. The method of claim 16, wherein applying the demographic correction model to correct the at least one computer-generated misattribution error comprises applying the demographic correction model to correct at least one computer-generated misattribution error in which inaccurate demographics were assigned to impressions logged in connection with a subset of the registered users who are not panelists of the audience measurement entity.

18. The method of claim 16, wherein modifying the second demographic data based on the first demographic comprises assigning at least a portion of the first demographic data to the panelist user account.

19. The method of claim 16, wherein:
the audience measurement computing system is further configured to:
transmit impression responses to the client devices to cause the client devices to transmit the network communications to the database proprietor computing system, and
the method further comprises:
in response to receiving the network communications, accessing cookies set on the client devices by the database proprietor computing system;
identifying the client devices based on the accessed cookies; and
logging the database proprietor impression data based on the identification of the client devices.

20. The method of claim 16, wherein the audience measurement computing system is further configured to:
based on the correction of the at least one computer-generated misattribution error in the database proprietor impression data, generate an audience metrics report based on the database proprietor impression data and the panel data.
